(19) United States
(12) Patent Application Publication
(10) Pub. No.: US 2026/0366260 A1
(43) Pub. Date: Nov. 19, 2026

(54) COMPACT TOOL CARRIER HAVING A SUSPENSION SYSTEM

(71) Applicant: Vermeer Manufacturing Company, Pella, IA (US)

(72) Inventors: Mason Carl Prieksat, Pella, IA (US); Stephen Daining, Pella, IA (US); Jack Henry Jaros, Pella, IA (US); James Wesley Skinner, Pella, IA (US)

(21) Appl. No.: 19/133,543

(22) PCT Filed: Dec. 1, 2023
(86) PCT No.: PCT/US2023/082170

§ 371 Date: May 28, 2025

Related U.S. Application Data
(60) Provisional application No. 63/385,724, filed on Dec. 1, 2022.

(51) Int. Cl. E02F 3/34; B62D 51/02; B62D 55/06; B62D 55/108; E02F 9/16

(52) U.S. Cl. CPC E02F 3/3414; B62D 51/02; B62D 55/06; B62D 55/1083; E02F 9/166

(57) ABSTRACT

Compact tool carriers are disclosed. The carrier defines a longitudinal axis extending through a front and rear of a chassis. A tool is connected to the chassis at the front. The carrier includes a drive including a track frame for moving the carrier. A front suspension assembly is attached to the chassis proximate the front that includes a flexibly mounted bar defining a first transverse axis and an arm connected at a first end to the bar extending obliquely therefrom to a second end. A torsion bar is rotationally fixed to the arm at the second end and extends therefrom along a second transverse axis parallel to, and longitudinally rearward of, the first transverse axis. A connector link is rotationally fixed to the torsion bar and the track frame is transversely between the pivot connector and the arm.

### CROSS REFERENCE TO RELATED APPLICATIONS

This application claims the benefit of priority to U.S. Provisional Patent Application No. 63/385,724, filed Dec. 1, 2022, the contents and disclosure of which are incorporated by reference herein in their entirety.

### FIELD OF THE DISCLOSURE

The field of the disclosure relates to compact tool carriers, or more broadly, work machines, that have a suspension system for cushioning of a chassis of the compact tool carrier.

### BACKGROUND

Work machines such as compact tool carriers and some mowers may be operated from a standing position in which the operator stands on a platform. Work machines often travel over uneven terrain which causes the machine to suddenly move up or down. For example, as the machine travels over a bump or other obstacle, vertical movement of the machine translates to the operator. Human factors research indicate that humans can detect changes in ground angle generally greater than 2 degrees, meaning that a change in angle of the machine relative to the ground, may result in an operator feeling unstable on a platform. Additionally, travelling over uneven terrain, as well as operation of the work tool (e.g., loading and unloading material from a loader bucket) may also result in shock and vibrations being imparted to the operator, as well as to the machine components. A reduction of shock and vibration, in particular to the engine, can result in increased life of machine components. Furthermore, operation of the work tool (e.g., loading and unloading material from the loader bucket) or loader arm loading may cause the machine to “nose-dive”, i.e. the weight of a load causes the front portion of the frame to be lower to the ground than when no load is present.

A need exists for work machines that are more stable and that reduce transmission of shock and vibration from the terrain and drive components to the operator, chassis, and components carried by the chassis. A still further need exists for work machines, in particular, track driven compact tool carriers, for a track drive with a suspension system that provides increased stability in both loaded and unloaded conditions.

This section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

One aspect of the present disclosure is directed toward a compact tool carrier. The carrier includes a chassis having a front and a rear, the compact tool carrier defining a longitudinal axis extending through the front and rear. The carrier further includes a tool connected to the chassis at the front and a ground engaging drive mechanism for moving the compact tool carrier. The drive mechanism includes a track frame defining an opening therein. The carrier further includes a suspension assembly attached to the track frame and the chassis. The suspension assembly includes a flexibly mounted bar defining a first transverse axis and an arm connected at a first end to the bar and extending obliquely therefrom to a second, opposed end. The suspension assembly further includes a torsion bar having a first and a second end, the first end rotationally fixed to the arm at the second end of the arm. The torsion bar extends along a second transverse axis from the arm that is parallel to and longitudinally rearward of the first transverse axis. The suspension assembly further includes a connector link rotationally fixed to the second end of the torsion bar at a first end of the connector link and pivotally attached to the track frame at a second end of the connector link, wherein the track frame is positioned transversely between the connector link and the arm.

Another aspect of the present disclosure is directed toward a suspension assembly for a compact tool carrier including a chassis. The suspension assembly includes a torsion axle configured to attach to the chassis, the torsion axle including a bar, the bar defining a first transverse axis. The suspension assembly further includes an arm connected at a first end to the bar and extending obliquely therefrom to a second, opposed end. The arm includes a shaft at the second end for rotationally securing the first end of a torsion bar thereto that extends along a second transverse axis that is parallel to the first transverse axis. The suspension assembly further includes a torsion link pivotally attached at a first end of the torsion link to the shaft of the arm and pivotally attached at a second end of the torsion link to a track frame of the compact tool carrier. A connector link is attached to a second end of the torsion bar and the torsion link. The torsion bar resists pivotal movement of the torsion link relative to the torsion axle.

Another aspect of the present disclosure is directed toward a suspension system for a compact tool carrier that includes a rear suspension assembly configured for attachment to a rear end of a chassis of the compact tool carrier. The rear suspension assembly is configured to connect the chassis to a track frame of the carrier and includes a first spring. The suspension system further includes a front suspension assembly configured for attachment to a front end of the chassis. The front suspension assembly is configured to connect the chassis to the track frame and includes a second spring and a linear spring configured to transfer forces from the front suspension assembly to the rear suspension assembly.

Another aspect of the present disclosure is directed toward a compact tool carrier that includes a chassis having a front and a rear, the compact tool carrier defining a longitudinal axis extending through the front and rear. The carrier further includes a ground engaging drive mechanism for moving the compact tool carrier. The drive mechanism includes a track frame defining an opening therein. The carrier further includes a front suspension assembly attached to the chassis proximate the front. The front suspension assembly includes a front torsion axle including a flexibly mounted bar defining a first front transverse axis and an arm connected at a first end to the bar. The arm extending obliquely therefrom to a second, opposed end, the arm including a shaft at the second end. The front suspension assembly further includes a torsion bar rotationally fixed to the shaft that extends along a second front transverse axis from the arm that is parallel to and longitudinally rearward of the first front transverse axis. The front suspension assembly further includes a torsion link pivotally attached to the shaft of the arm extending along a third front transverse axis. The front suspension assembly further includes a connector link rotationally fixed at a first end of the connector link to the torsion bar at a second end of the torsion bar, the torsion link being connected to a second end of the connector link. The carrier further includes a rear suspension assembly attached to the chassis proximate the rear. The rear suspension assembly includes a rear torsion axle defining a first transverse rear axis and a torsion arm connected to the rear torsion axle, the torsion arm defining a second transverse rear axis.

Another aspect of the present disclosure is directed toward a suspension system for a compact tool carrier comprising that includes a rear suspension assembly configured for attachment to a rear end of a chassis of the compact tool carrier. The rear suspension assembly being configured to connect the chassis to a track frame of the carrier and including a first rubber torsion element. The suspension system further includes a front suspension assembly configured for attachment to a front end of the chassis. The front suspension assembly is further configured to connect the chassis to the track frame and includes a second rubber torsion element and a linear spring, where rotation of the second rubber torsion element provides a linear increase in a rotational moment to the linear spring.

Another aspect of the present disclosure is directed toward a method of assembling a compact tool carrier that includes connecting a tool to a front end of a chassis of the carrier. The carrier defining a longitudinal axis extending through the front end of the chassis and an opposed rear end. The method further includes connecting a ground engaging drive mechanism to the chassis by connecting a front suspension assembly attached to the chassis to the ground engaging drive mechanism. The front suspension assembly includes a flexible torsion axle attached to the chassis and an arm connected at a first end to the flexible torsion axle and extending obliquely therefrom to a second, opposed end. The arm includes a shaft at the second end and the front suspension assembly further includes a pivot link that is rotatably connected to the shaft and the ground engaging drive mechanism. The method further includes rotationally fixing, after connecting the tool and connecting the ground engaging drive mechanism, a torsion bar to the shaft of the arm and to the pivot link of the front suspension assembly.

Another aspect of the present disclosure is directed toward a suspension assembly for pivotally connecting a chassis of a compact tool carrier to a drive mechanism. The suspension assembly includes a torsion axle having a bar flexibly mounted to the chassis, the bar defining a first transverse axis and an arm connected at a first end to the bar and extending obliquely therefrom to a second, opposed end. The suspension assembly further includes a torsion bar rotationally fixed to arm at the second end and extending along a second transverse axis from the arm that is parallel to and longitudinally rearward of the first transverse axis. The suspension assembly further includes a torsion link including a torsion arm and a torsion shaft. The first end of the torsion arm pivotally connected to the second end of the arm and extending therefrom along a third transverse axis that is parallel to and offset from the first transverse axis. A connector link is fixed to the torsion bar at a first end of the connector link and rotationally fixed to the shaft of the torsion link.

The connector link restricts transverse movement of the link and torsion bar relative to the drive mechanism.

Another aspect of the present disclosure is directed toward a compact tool carrier defining a front, a rear, and a longitudinal axis extending through the front and the rear. The carrier includes a chassis, a drive mechanism configured to move the compact tool carrier in a drive direction that is generally parallel to the longitudinal axis, and a suspension system pivotally connecting the drive mechanism to the chassis. The suspension system includes a front torsion assembly and a rear torsion assembly including an outer tube. The carrier further includes an engine positioned at least partially within the chassis and configured to power the drive mechanism and an oil pan positioned below the engine. The oil pan includes a front face and a rear face opposite the front face. The front face of the oil pan is positioned longitudinally rearward of the outer tube of the rear torsion assembly.

Another aspect of the present disclosure is directed toward a compact tool carrier defining a front, a rear, and a longitudinal axis extending through the front and the rear. The carrier includes a chassis and a drive mechanism configured to move the compact tool carrier in a drive direction that is generally parallel to the longitudinal axis. The carrier further includes a suspension system pivotally connecting the drive mechanism to the chassis. The suspension system includes a front torsion assembly and a rear torsion assembly including an outer tube. The carrier further includes an engine coupled to the chassis for powering the drive mechanism and an oil pan positioned below the engine. The oil pan includes a front face, a rear face opposite the front face, and a bottom side extending between the front face and the rear face. The bottom side is positioned vertically above a lowest point of the outer tube.

Another aspect of the present disclosure is directed toward a compact tool carrier that includes a chassis having a front and a rear, the compact tool carrier defining a longitudinal axis extending through the front and rear. The chassis defining a first air passage and a second air passage. The carrier further includes an operator station connected to the chassis at the rear and including a platform to support an operator thereon and a heat exchanger positioned within the chassis longitudinally adjacent to the operator station. The carrier further includes a fan configured to direct air over the heat exchanger. The fan is operable in a first direction to intake air through the first air passage and exhaust air through the second air passage and away from the platform. The fan is further operable in a second direction to intake air through the second air passage and exhaust the air through the first air passage and toward the platform.

Another aspect of the present disclosure is directed toward a compact tool carrier that includes a chassis having a front and a rear. The compact tool carrier defining a longitudinal axis extending through the front and rear. The carrier further includes an operator station connected to the chassis at the rear and including a standing platform to support an operator thereon. The carrier further includes an operator station suspension system connecting the operator station to the chassis, the operator station suspension system including an air spring. The carrier further includes a sensor for detecting a presence of an operator on the standing platform, the sensor including a pressure sensor configured to detect an air pressure of the air spring.

Another aspect of the present disclosure is directed toward a compact tool carrier that includes a chassis having a front and a rear. The compact tool carrier defining a longitudinal axis extending through the front and rear. The carrier further includes a first loader arm and a second loader arm that are each pivotally connected to the chassis. The carrier further includes an attachment plate pivotally connected to the arms and configured to receive a tool of the carrier thereon. The carrier further includes a tilt actuator for adjusting an orientation of the attachment plate relative to the arms. The tilt actuator is pivotally attached to the first loader arm and is positioned closer to the first loader arm than the second loader arm.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a perspective view of a compact tool carrier including a removable tool, with certain components hidden for illustration;

FIG. 2 is a top view of compact tool carrier;

FIG. 3 is another perspective view of the compact tool carrier, showing the tool removed;

FIG. 4 is a perspective view of a chassis of the compact tool carrier;

FIG. 5 is another perspective view of the chassis;

FIG. 6 is a side view of the chassis;

FIG. 7 is another side view of the compact tool carrier having components hidden to reveal internal components of the compact tool carrier;

FIG. 8 is a side view of the operator station;

FIG. 9 is a perspective view of the operator station.

FIG. 10 is another perspective view of an operator station of the compact tool carrier;

FIG. 11 is a perspective view of a drive mechanism of the compact tool carrier, having components hidden to show a drive assembly;

FIG. 12 is a partially exploded view of the drive mechanism shown in FIG. 11;

FIG. 13 is an exploded view of the rear torsion assembly

FIG. 14 is a perspective view of a portion of the compact tool carrier, having components hidden to show a portion of a drive assembly;

FIG. 15 is a perspective view of the region A, shown in FIG. 9, showing a rear suspension assembly of the compact tool carrier;

FIG. 16 is a partially exploded view of a front suspension assembly of the compact tool carrier;

FIG. 17 is a perspective view of the region B, shown in FIG. 14, showing the front suspension assembly;

FIG. 18 is another partially exploded view of the front suspension assembly;

FIG. 19 is a perspective view of a portion of the compact tool carrier, having components hidden to show a portion of the drive assembly and suspension assemblies;

FIG. 20 is a schematic side view of the compact tool carrier;

FIG. 21 is a schematic side view of the compact tool carrier in an unloaded condition;

FIG. 22 is a schematic side view of the compact tool carrier in a loaded condition;

FIG. 23 is a schematic side view of the compact tool carrier in a breakout condition;

FIG. 24 is another perspective view of the compact tool carrier, showing the compact tool carrier in a servicing configuration;

FIG. 25 is a side view of the compact tool carrier having components hidden to reveal internal components of the compact tool carrier;

FIG. 26 is a bottom view of the compact tool carrier shown in FIG. 25;

FIG. 27 is another perspective view of the compact tool carrier in the servicing configuration;

FIG. 28 is another perspective view of the compact tool carrier in the servicing configuration;

FIG. 29 is an end view of a portion of the compact tool carrier in the servicing configuration; and

FIG. 30 is a perspective view of an oil cooler of the compact tool carrier;

Corresponding reference characters indicate corresponding parts throughout the drawings.

### DETAILED DESCRIPTION

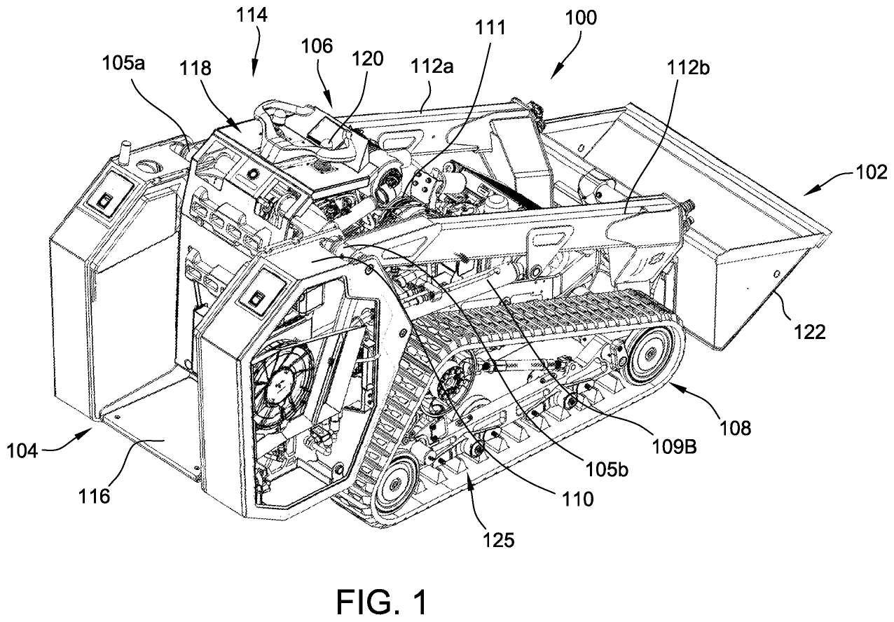

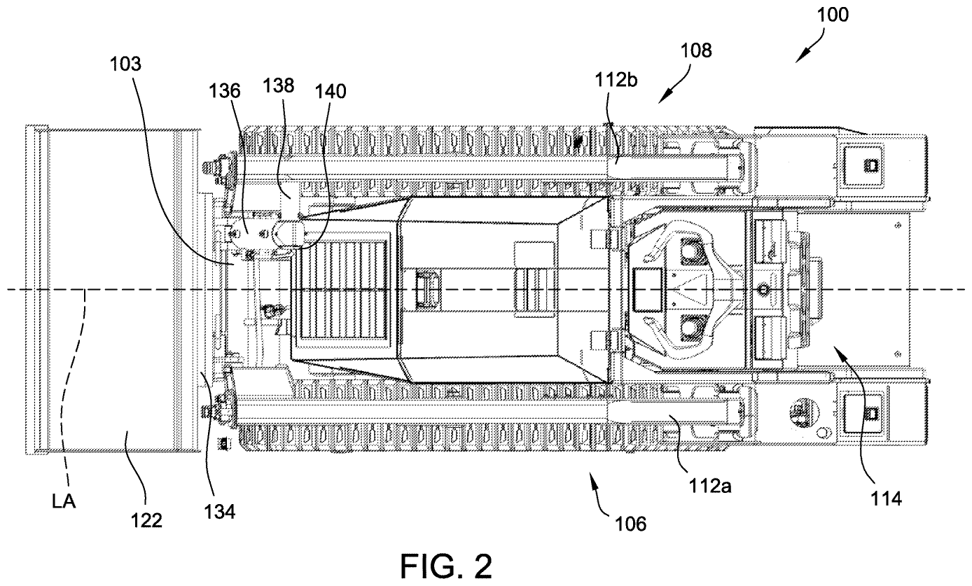

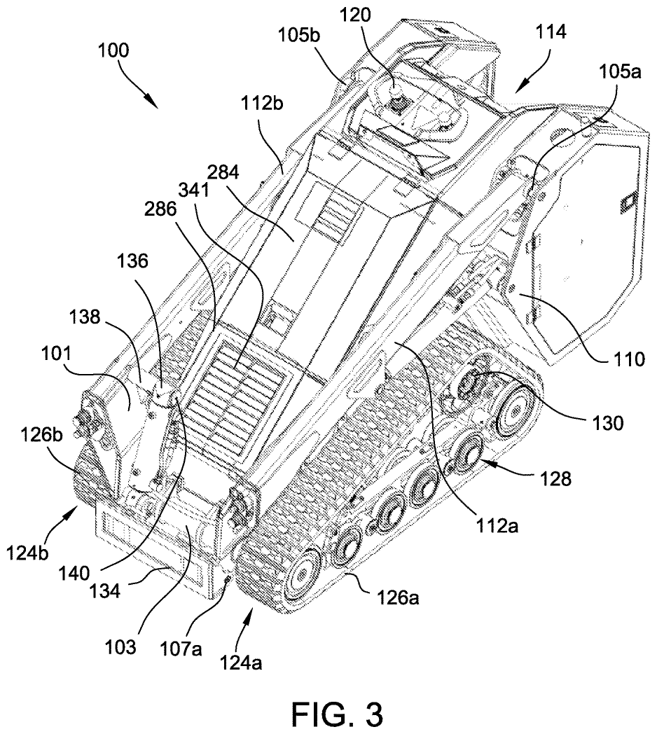

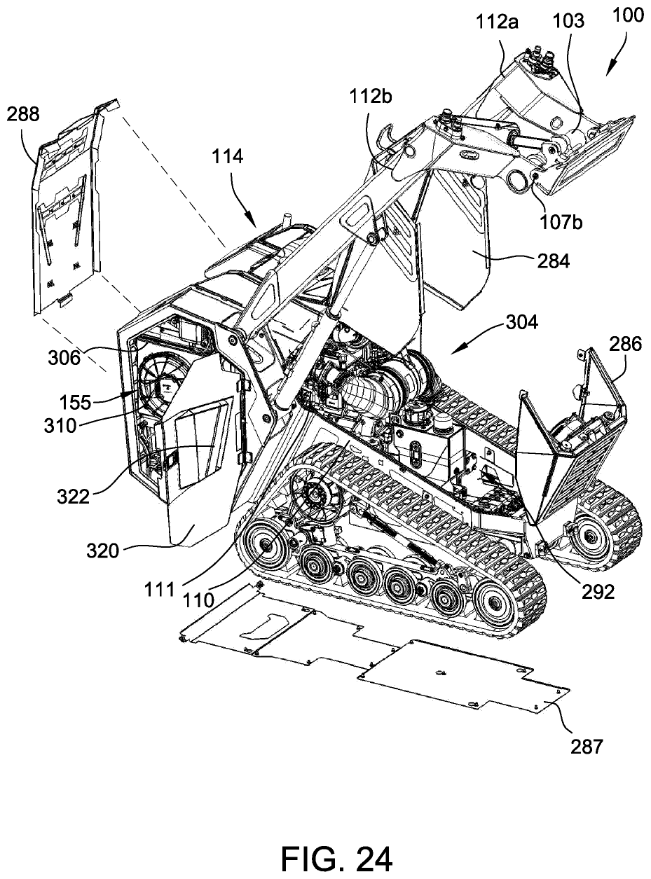

Referring to FIG. 1, an embodiment of a compact tool carrier 100 is shown. As shown in FIG. 1, components of the compact tool carrier 100 are hidden, such as a compartment door 320 (shown in FIG. 24), and upper and lower hoods 284, 286 (shown in FIG. 3). The compact tool carrier 100 includes a front 102, a rear 104, a first side 106, a second side 108, and a longitudinal axis LA (FIG. 2) that extends between the front 102 and rear 104.

As used herein, “compact tool carrier” (also referred to herein as a “carrier”, “compact loader”, and/or a “mini skid steer”) refers to machines that are self-propelled and are capable of carrying interchangeable equipment. At the time of filing, the definition “compact tool carrier” is provided in ISO 6165(2012 ) and SAE J2752, as generally have a mass (not including the interchangeable tool) of less than about 1500 kg (about 3307 lbs.), which said standards are hereby incorporated herein by reference for all relevant and consistent purposes. It is contemplated that such standards may increase or decrease mass requirements over time. However, regardless of the specific requirements of the standards, use of the term “compact tool carrier” herein is intended to exclude full size skid steers (e.g., seat-operated units) due to a large variation in weight, complexity, and size.

Referring to FIG. 2, the longitudinal axis LA is parallel to the first side 106 and the second side 108 of the compact tool carrier 100 (i.e., parallel to its length). The compact tool carrier 100 is longitudinally symmetrical in certain aspects (i.e., relative to the longitudinal axis LA) in that several components have a corresponding component with the same function opposite the component (i.e., across the axis LA). Corresponding components of the pair may be indicated herein by use of a reference number followed by “A” and “B” and may be referred to as a “first” component and a “second” component, respectively. While the compact tool carrier 100 may be described herein with reference to the components of one side of the compact tool carrier 100, any component designated by “A” or “B” herein or shown in the figures includes a corresponding component with the same function opposite the component.

Referring back to FIG. 1, the compact tool carrier 100 includes a chassis 110 (e.g., frame, subframe, or multi-part frame) that supports a loader 101. The loader 101 is pivotally attached to chassis 110 at loader pivot mounts 105a, 105b by first loader arm 112a and a second loader arm 112b. Each arm 112a, 112b may be a single weldment or may include various components attached by fasteners (e.g., nuts and bolts). Loader arms 112a, 112b may be tied together by loader crossmember 103 by welding or fasteners.

As shown in FIG. 3, the loader 101 of compact tool carrier 100 includes an attachment plate 134 pivotally attached at attachment plate pivots 107a, 107b to loader arms 112. Attachment plate 134 serves as a mounting location for releasably attaching the tool 122, such as the bucket illustrated FIG. 1, to the compact tool carrier 100. Other tools (e.g., interchangeable tools) include augers, forks, stump grinders, tillers, rollers or the like may be connected to the attachment plate 134. The angular orientation of attachment plate 134 is controlled by tilt actuator 136, which is described in detail further below.

Actuators 109a, 109b, shown as hydraulic cylinders, are pivotally attached at a first end to the chassis 110 and pivotally attached to the loader arms 112a, 112b at a second end (FIG. 1). Extension and retraction of actuators 109 raises and lowers loader 101, respectively.

A tilt actuator 136, shown as a hydraulic cylinder, is pivotally attached to second loader arm 112b by a tilt actuator mount 138 (FIG. 3). The tilt actuator mount 138 is a cylindrical shaft that is rigidly attached (e.g., by welding) to the second loader arm 112b. The tilt actuator mount 138 extends transversely inwards from the second arm 112b and to a free distal end 140. The tilt actuator 136 pivotally attaches at a first end to tilt actuator mount 138 and pivotally attaches at a second end to attachment plate 134. The tilt actuator 136 is a linear actuator and may be hydraulically or pneumatically actuated to adjust an angular orientation of the attachment plate 134 (and, as a result, any attached tool) during operation, such as, for example and without limitation, when picking up or depositing a load of soil from the bucket shown in FIG. 1.

Referring to FIG. 2, the tilt actuator 136 is transversely offset from a vertical center plane extending along the central longitudinal axis LA of the compact tool carrier 100 (i.e., the vertical center plane is midway between the first and second sides 106, 108). In particular, the tilt actuator 136 is transversely offset from a forward line of sight of an operator at the operator station 114 which, in the illustrated embodiment, is generally along the longitudinal axis LA. The tilt actuator 136 is positioned between the second loader arm 112b and the center plane extending along the longitudinal axis LA. The tilt actuator 136 does not cross the vertical center plane. Accordingly, the tilt actuator 136 provides an improved view of the attachment plate 134 and/or the tool 122 to the operator, which may be beneficial for positioning the attachment while working and coupling tools. For example, having the tilt actuator 136 offset from the center plane as shown in FIG. 2 may be particularly beneficial where the tool 122 is a tool having a working portion along the central plane of the machine, such as post hole diggers, grapples, jackhammer, or a vibratory plow. The actuator 136 may be placed far to the side in close proximity to the second loader arm 112b, or in other embodiments may be mounted on the first loader arm 112a and offset from the vertical center plane that extends through the longitudinal axis LA on the first side 106 of the compact tool carrier 100. The embodiment described above and shown in the figures utilizes a single tilt actuator, other embodiments may contain two tilt actuators, one on either side of a vertical center plane that extends through longitudinal axis LA, for example each tilt actuator may be mounted at a first end to arm 112a, 112b, respectively, and pivotally connected at a second end to attachment plate 134.

### Chassis

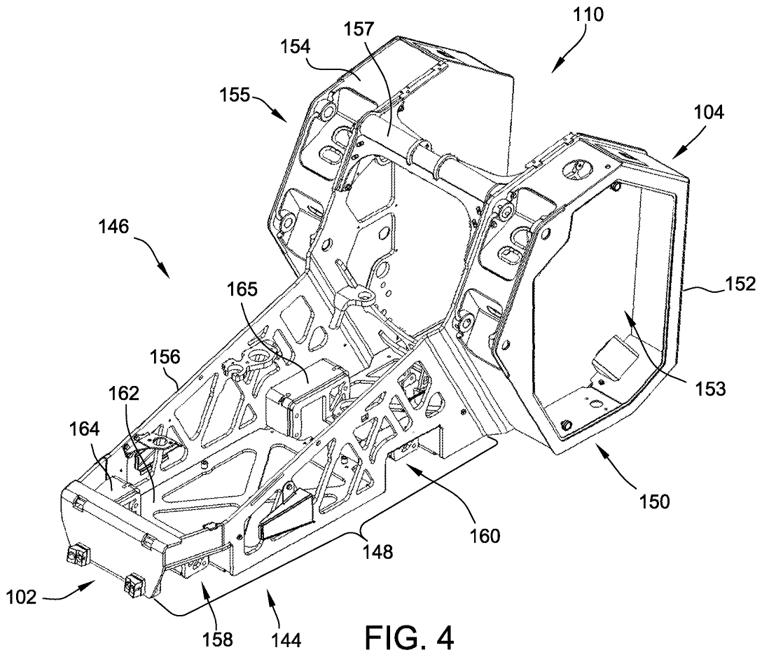

As mentioned, the loader 101 is pivotally attached to chassis 110. Referring to FIGS. 4, 5, and 6 the chassis 110 includes a first side 144 and a second side 146 generally opposite the first side 144. The chassis 110 generally includes a basket section 148 and a cradle section 150. The basket section 148 is forward of the cradle section 150 relative to the longitudinal axis LA (FIG. 2). The cradle section 150 includes a first compartment frame 152 and a second compartment frame 154 transversely spaced from the first compartment frame 152 that at least partially define the operator station 114 (FIG. 2) therebetween. A cross bar 157 extends between the compartment frames 152, 154. Cross bar 157 provides a mounting location for operator station 114 (described in detail below) and may optionally provide an enclosure for loader pivot mounts 105a, 105b. In the exemplary embodiment, the cross bar 157 is a separate weldment from the remainder of the chassis 110 (i.e. cross bar 157 is attached to chassis compartment frames 152, 154 by fasteners), though in other embodiments, the chassis 110 may be unitarily formed (i.e. welded) or part of a single-piece construction with the chassis 110. Each of the compartment frames 152, 154 define a respective compartment 153, 155 therein for receiving one or more components of the compact tool carrier 100, as described in greater detail below.

The basket section 148 includes a basket frame 156 that extends forward from the first and second compartment frames 152, 154, respectively, toward the front 102 of the compact tool carrier 100. The basket frame 156 defines front and rear axle cavities 158, 160 on each of the first and second sides 144, 146 for receiving a portion of the suspension system 132 therein, as described in greater detail below. The basket frame 156 includes a base 162 defining a floor of the chassis 110 and axle steps 164, 165 which protrude upward from the base 162 and define the respective axle cavities 158, 160 therein. In the illustrated embodiment, an engine 111 for propelling the drive mechanism and powering other machine functions is connected to the chassis 110 and at least partially rearward of the rear axle steps 165. The engine 111 may be a diesel engine or any other engine known in the art, such as a gasoline engine, a gaseous fuel driven engine, or any other engine known in the art. It is also contemplated that the engine 111 may alternately include another source of power such as a fuel cell, a power storage device, an electric or hydraulic motor, and/or another source of power known in the art. The engine 111 may be operatively connected to the drive system 125(described in greater detail below) by any suitable manner known in the art, such as, for example, gearing, a countershaft, hydraulic lines or fittings, and/or a belt.

### Operator Station

The compact tool carrier 100 further includes an operator station 114 at the rear 104 (FIG. 1). The operator station includes an operator standing platform 116 (or simply “standing platform” or even “platform”). The operator standing platform 116 is fully supported by the chassis 110 and does not have one or more separate wheels mounted to the platform such as with a “sulky” or “dolly” type operator platform. For example, the operator standing platform 116 may be rigidly mounted to the chassis 110, pivotally mounted to chassis 110, or mounted to chassis by a suspension system.

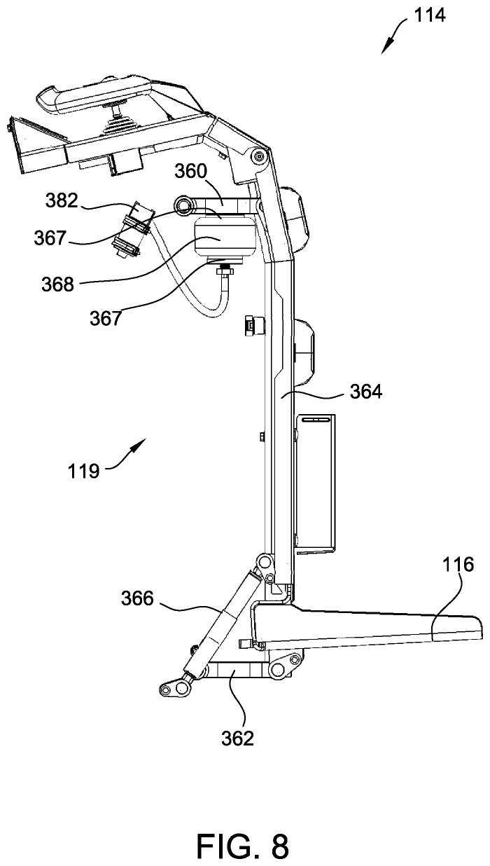

The illustrated embodiments show operator station 114 suspended from the chassis 110 by an operator suspension system 119 (FIG. 8) (i.e., a system that cushions shock and/or dissipates vibrations by one or more suspension elements that connect the operator station 114 to the chassis 110). The operator station 114 is mounted toward the rear 104 of the compact tool carrier 100 (i.e., opposite the tool 122) and is generally adapted to allow for standing or walk-behind operation. As used herein, “standing operation” generally refers to operation in which the operator stands on a platform attached to the compact tool carrier while “walk-behind operation” generally refers to operation in which the operator stands on the surface supporting the compact tool carrier 100. The operator station 114 is “open”, in that it does not have an enclosed cab and/or cabin for covering the operator.

The operator station 114 also includes a control station 118 that includes one or more controls 120 for operating the compact tool carrier 100 (FIG. 1). The control station 118, as part of the operator station 114, is suspended from the chassis 110. The controls 120 include controls for controlling propulsion of the compact tool carrier and/or for raising and lowering the loader arms 112a, 112b. Other suitable controls 120 include a direction and speed control (shown as a joystick) for propelling the machine forward and backward and for steering the machine, lift/tilt controls for raising and lowering the loader arms 112a, 112b and for tilting the tool 122 (e.g., loader bucket), an auxiliary power control, a fluid direction control, and an ignition control. The controls of the control station 118 of the illustrated embodiment are exemplary and other controls and combination of controls may be used unless stated otherwise. In some embodiments, the control station 118 may include substantially the same controls as described in International Patent Application No. PCT/US2021/044393, the entire contents of which are hereby incorporated by reference for all relevant and consistent purposes.

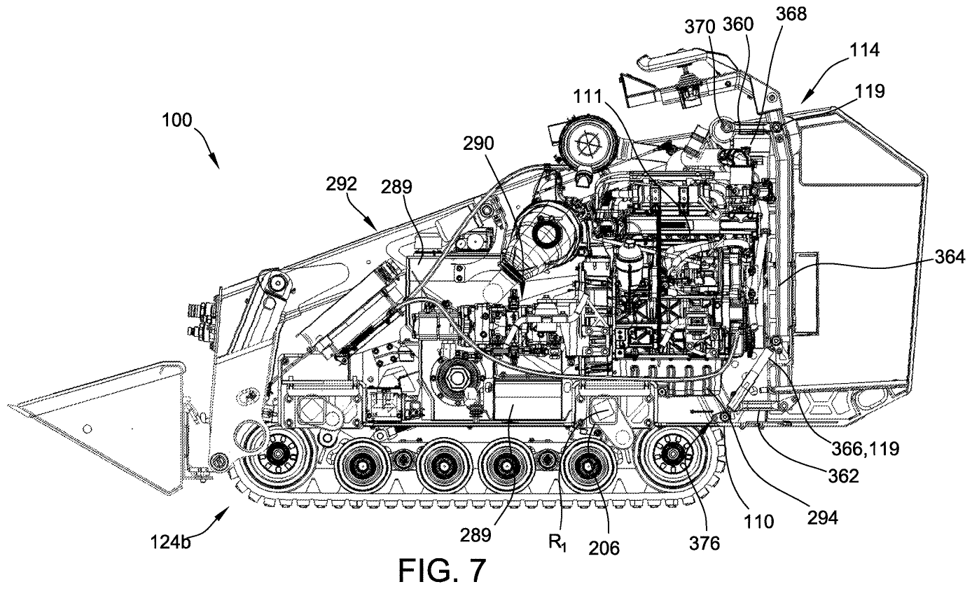

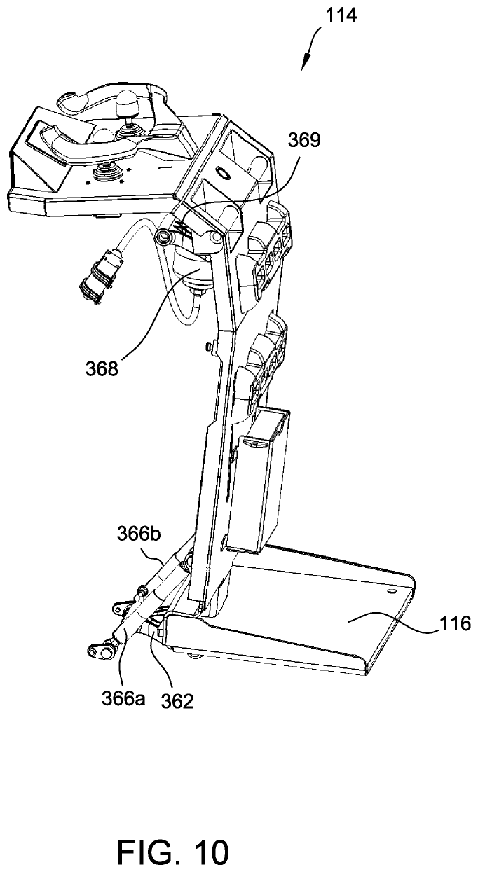

Referring to FIGS. 7-10, the compact tool carrier 100 further includes an operator suspension system 119 connecting the operator station 114 to the chassis 110. The operator suspension system 119 includes at least one upper linkage 360 and at least one lower linkage 362 that are each pivotally connected to the chassis 110 and are each pivotally connected to the operator station 114, or more specifically, to a support frame 364 of the operator station 114. The operator suspension system 119 includes one or more shock absorbers 366 and one or more air springs 368.

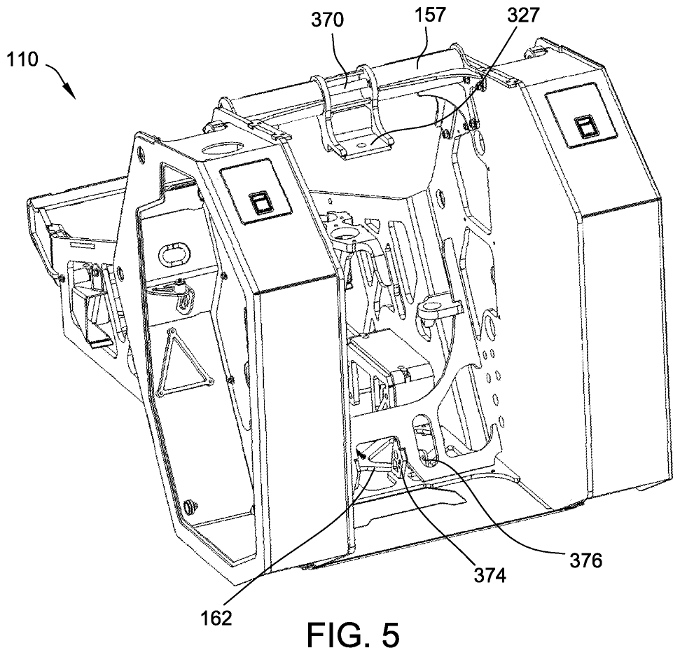

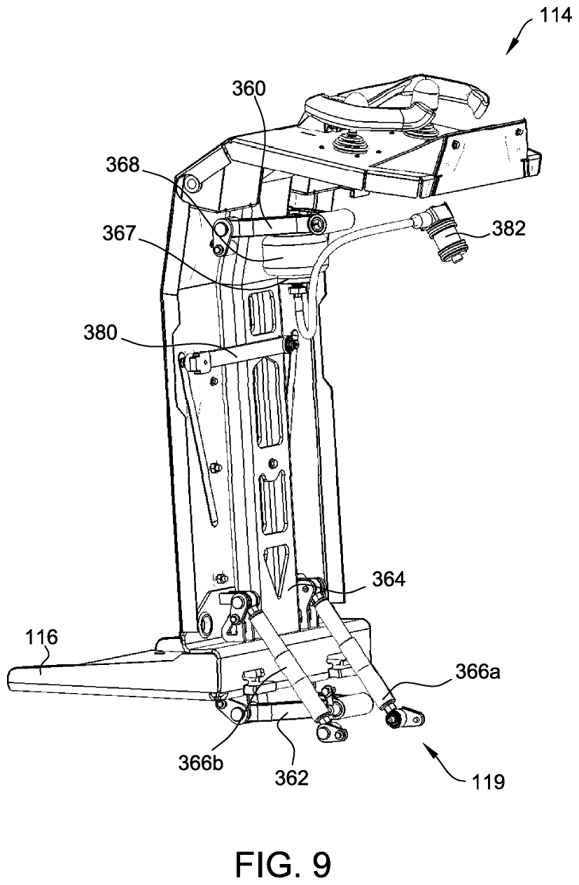

Referring to FIG. 5, the chassis 110 includes an upper linkage mount 370 connected to the cross bar 157 and an air spring mount 327 that extends from the upper linkage mount 370. The chassis 110 further includes a lower linkage mount 374 and shock absorber mount 376 positioned on the base 162 of the chassis 110. The upper linkage 360 (FIG. 7) pivotally connects to the upper linkage mount 370. The air spring mount 327 holds the air spring 368 (FIG. 7) thereon. The lower linkage 362 (FIG. 7) pivotally connects to the lower linkage mount 374. The shock absorbers 366 (FIG. 7) pivotally connect to the shock absorber mount 376. In the exemplary embodiment, a pair of shock absorbers 366a, 366b are provided, as shown in FIG. 9.

Referring back to FIG. 7, the upper and lower linkages 360, 362 control movement of the operator station 114 as the compact tool carrier 100 travels over uneven terrain. The upper and lower linkages 360, 362 extend generally parallel to the ground (i.e., without being substantially angled upward or downward). As a result, during operation, movement of the operator station 114 is generally vertical. In the illustrated embodiment, the operator suspension system 119 further includes a sway bar 380 (FIG. 9) (e.g., a panhard rod or watt's link) to control or reduce lateral movement of the operator station 114 relative to the chassis 110. Sway bar 380 is pivotally connected at a first end to the chassis and at the second end to the operator station support frame 364. In other embodiments, the sway bar 380 may not be included.

As mentioned, the shock absorbers 366a, 366b (FIG. 9) are pivotally connected to the shock absorber mount 376 (FIG. 5) of the chassis 110 and pivotally connect to the operator station frame 364. Suitable shock absorbers 366 may include a piston rod which acts upon a hydraulic fluid that may be pushed and pulled through orifices in the shock absorber. The illustrated shock absorber is a damper that dissipates kinetic energy by converting it to heat. In other embodiments, the shock absorber 366 may generally be any shock absorber available to those of skill in the art.

Referring to FIGS. 7 and 9, a lower face 367 of the air spring 368 is positioned against the air spring mount 327 (FIG. 5) and an upper face (not shown) of the air spring 368 is positioned in contact with the upper linkage 360. The upper linkage 360 of the illustrated embodiment includes a structure 369 (i.e. plate) extending generally horizontally (across the width) of the linkage. The structure 369 provides a large surface area for distributed contact with the air spring 368.

The air spring 368 utilizes a suspension sensor (not show), such as a pressure sensor, to sense the amount of cushioning provided by the air spring 368. In some embodiments, the suspension sensor transmits a reading to the control station 118 for display to the operator, indicating stiffness setting of the operator suspension system 119. The air spring 368 generates a relatively low natural frequency (e.g., below 1.5 Hertz) which is beneficial for shock absorption and vibration isolation.

The operator suspension system 119 is adjustable to change the amount of cushioning provided by the air spring 368 by changing the air pressure within the air spring 368. The air pressure in the air spring 368 may be selectable by the operator through controls on the control station 118 which transmits a signal to the controller (not shown). The controller controls a valving system (not shown) and/or compressor 382 (FIG. 8) to adjust and/or maintain the air pressure in the air spring 368 based on the operator requested setting. The operator suspension system 119 may include an air tank (not shown) for storing pressurized air.

In some embodiments, the operator may manually adjust the pressure in the air spring 368 by switches, buttons, or dials. In other embodiments, the controller of operator suspension system 119 may include a plurality of discrete settings to adjust for various operator weights. The operator suspension system 119 may be further configured to be locked in a fixed position (e.g., a rigid, non-suspended position). In some embodiments, the operator suspension system 119 may be configured to automatically adjust the stiffness (e.g., by controlling the air pressure in the air spring 368) based on a ride height of the compact tool carrier 100. The suspension system adjusts the stiffness of the air spring 368 to maintain the desired position of the frame 364 relative to the chassis, regardless of the operator weight. The ride height may be sensed by a mechanical system or sensors (not shown).

Some embodiments of the operator suspension system 119 may include secondary springs, such as coil or torsion springs (not shown) for supporting the operator station 114. These secondary springs may be particularly useful as a fail safe for supporting the operator station 114 and/or operator presence system if the air suspension system has leak, breakdown, or malfunction.

The operator suspension system 119 may include one or more sensors (not shown) for detecting the presence of an operator on the standing platform 116. For example, in some embodiments, when an operator steps on the platform, the air pressure in air spring 368 is increased, due to the increased forces acting on the upper linkage 360. The sensor (e.g., an air pressure sensor) may sense the pressure change in the air spring 368 and transmit a signal to the controller indicating the presence of an operator on the standing platform 116. The controller (not shown) may disable propulsion of the compact tool carrier 100 and/or operation of the tool 122 (FIG. 1) when an operator is not sensed by the operator presence system. In some embodiments, the controller (not shown) may be programmed based on a predetermined time delay, such that momentary changes in the operator detection (e.g., as a result of the compact tool carrier 100 driving over changes in terrain) do not trigger the controller to disable propulsion of the compact tool carrier 100.

In other embodiments, different systems may be used to detect operator presence on the standing platform 116. For example, in some embodiments, a position sensor (not shown) is used to detect a position of the operator station frame 364 or any other components of the operator station 114. In other embodiments, a weight sensing device (not shown) may be provided in the standing platform 116. Other suitable operator presence detection systems and operator station suspension systems are described in International Patent Application No. PCT/US2021/044393, the entire contents of which has been incorporated herein by reference for all relevant and consistent purposes.

The illustrated embodiments show a suspended operator station on compact tool carrier where the chassis is connected to a ground drive mechanism 125 having a suspension system (described in detail below), however, the operator suspension system 119 may be use on a compact tool carrier having a ground drive mechanism directly mounted (i.e., connected without intermediary suspension components) to the chassis 110, like that disclosed in U.S. Pat. No. 9,321,386. In other words, the operator suspension system is independent of the drive system suspension system. As shown, the drive mechanism 125 includes tracks 126. In other embodiments, the drive mechanism 125 includes wheels.

### Components of the Drive Mechanism

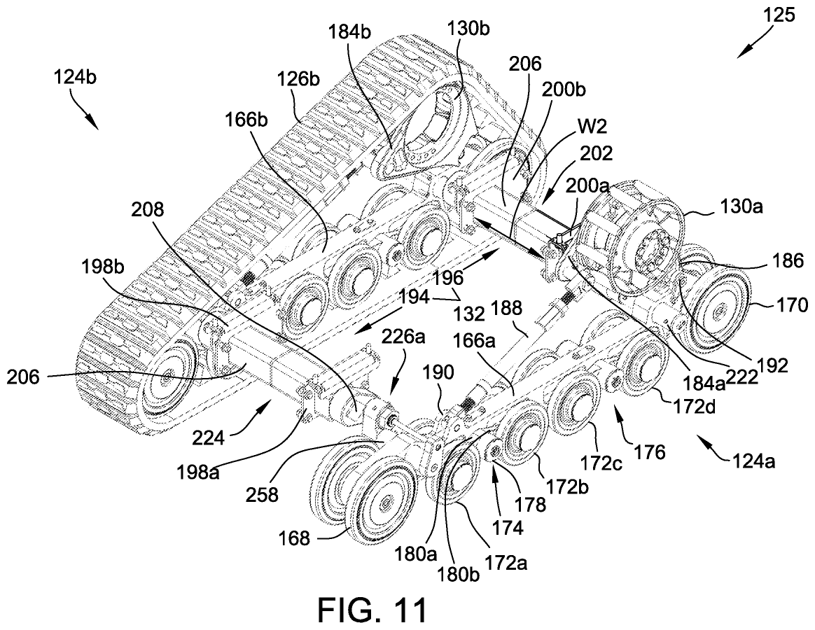

Referring to FIG. 3, the compact tool carrier 100 includes a first and second drive assemblies 124a, 124b (collectively referred to herein as a drive mechanism 125 (FIG. 11)) connected to the chassis 110. In the illustrated embodiment, the drive assemblies 124a, 124b each include a track 126, rollers 168, 170, 172 (FIG. 11) and a drive sprocket 130. The tracks 126a, 126b extend around at least a portion of an outer circumference of the corresponding rollers 168, 170, 172 and drive sprocket 130. Drive sprocket 130 may be powered by a hydraulic drive system such as a hydraulic motor (not shown), which is powered by a hydraulic pump (not shown) and the engine 111, to propel the compact tool carrier. The hydraulic drive system may be a dual-path hydrostatic transmission, although other transmissions known in the art may also be used, such as a mechanical or electrical variable-speed drive or gear-type transmissions. The hydraulic drive system may include a pair of variable displacement pumps and a left and a right drive motor coupled to the drive sprocket 130. The variable displacement pumps supply pressurized hydraulic fluid through supply lines to drive the left and right drive motors, which turn the drive sprockets 130.

FIG. 11 is a perspective view of a portion of the drive mechanism 125 of the compact tool carrier 100. In the illustrated embodiment, portions of the drive mechanism 125, such as first track 126a, are hidden to reveal internal construction. Each drive assembly 124a, 124b includes a track frame 166a, 166b extending generally longitudinally. Rollers 168, 170, 172a-d are rotatably connected to track frames 166a, 166b. More specifically, 168 may be referred to as a front idler, 170 referred to as a rear idler, and a plurality of mid-idler rollers 172a-d are positioned longitudinally between the front idler 168 and rear idler 170. The front idler 168 and rear idler 170 are each rigidly mounted to track frames 166 and configured for rotation relative thereto. The plurality of mid-idler rollers 172a-d may be arranged on each drive assembly 124a, 124b as pairs on rocker assemblies 174, 176. The rocker assemblies 174, 176 connect the mid-idler rollers 172 to the track frame 166. The rocker assemblies 174, 176 each include a rocker hub 178 that pivotally attaches rocker arms 180 to the track frame 166. The rocker arms 180a, 180b extend at least partially longitudinally outward from the rocker hub 178, in generally opposed directions, to the mid-idler rollers 172. In other embodiments, any one of the front idler 168, mid-idler rollers 172, and/or rear idler 170 may be connected to the track frame 166 by any suitable means such as, rigid mounting or by a suspension system (not shown). For example, in some embodiments a suspension system including a torsion element (not shown) may be attached to the track frame and an arm may attach the rollers 168, 170, 172 to the torsion element.

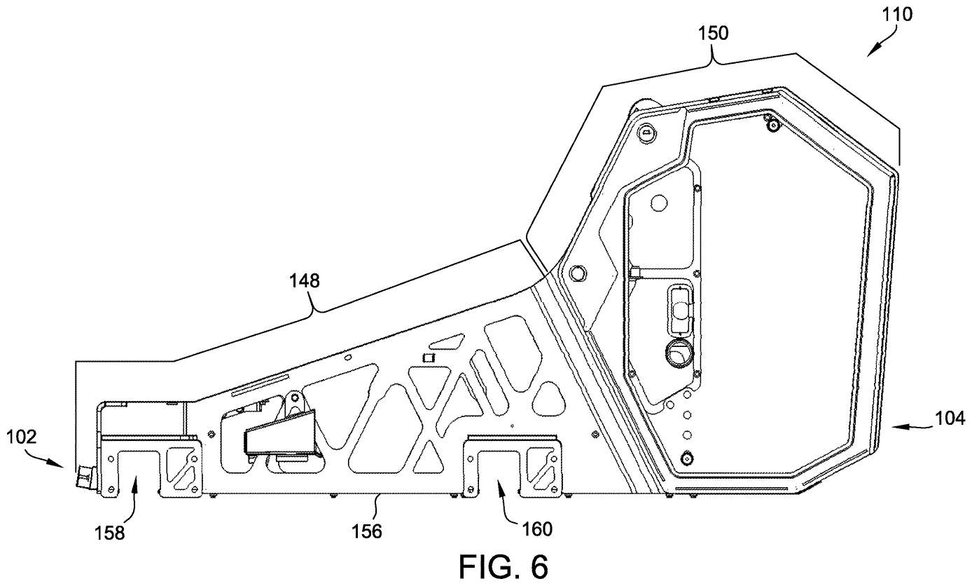

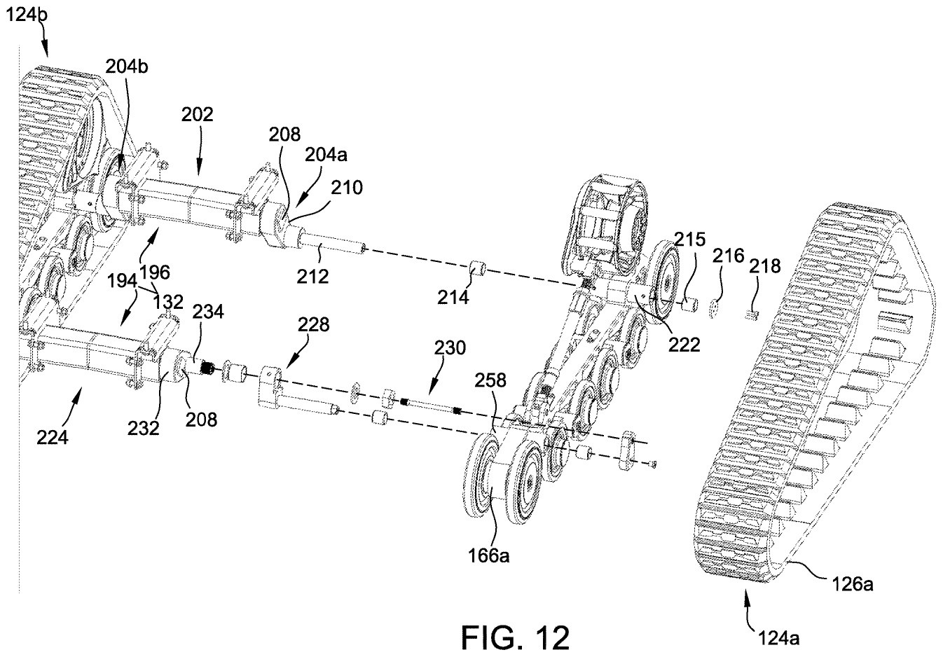

The drive sprockets 130 are attached to the track frame 166 by sprocket arm 186 (FIG. 11). The sprocket arm 186 is pivotally attached to a rear joint 192 that is pivotable relative to the track frame 166. Sprocket arm 186 has an extended portion 184 where a first end of a tie rod 188 is pivotally attached to sprocket arm 186. Tie rod 188, or similar, such as a turnbuckle, is pivotally attached at a second end to the track frame 166 at a front joint 190. The tie rod 188 is an example of a linear actuator that has an adjustable length to allow for adjustment in tension of the tracks 126 by pivoting the sprocket arm 186, thereby adjusting the tension in track 126 by changing the outer circumferential distance that track 126 wraps around rollers 168, 170, 172, and drive sprocket 130. In some embodiments the tie rod 188 may include damping features (not shown), such as a viscous fluid or spring. As described in greater detail below, drive assemblies 124a, 124b are each connected to chassis 110 by a suspension system 132 (FIG. 12). Referring to FIG. 11, the drive mechanism 125 further includes a front suspension assembly 194 and a rear suspension assembly 196 (collectively referred to as a “suspension system”). The suspension assemblies 194, 196 each pivotally attach to each of track frames 166a, 166b at opposed ends of the suspension assemblies 194, 196 and are configured to be rigidly mounted to the chassis 110 (FIG. 6), more specifically, the front suspension assembly 194 attaches to chassis 110 by brackets 198 and pivotally attaches to first and second track frames 166a, 166b at front housing 258 which is positioned between front idlers 168 and mid-idler rollers 172, and the rear suspension assembly 196 attached to chassis 110 by brackets 200 and pivotally attaches to the first and second track frames 166a, 166b at rear housing 222 which is positioned between the rear idler 170 and mid-idler rollers 172. Therefore, the front and rear suspension assemblies are tied together by track frame 166 and chassis 110. The rear shaft housing 222 and front housing 258 are securely attached to the track frame 166, such as by welding.

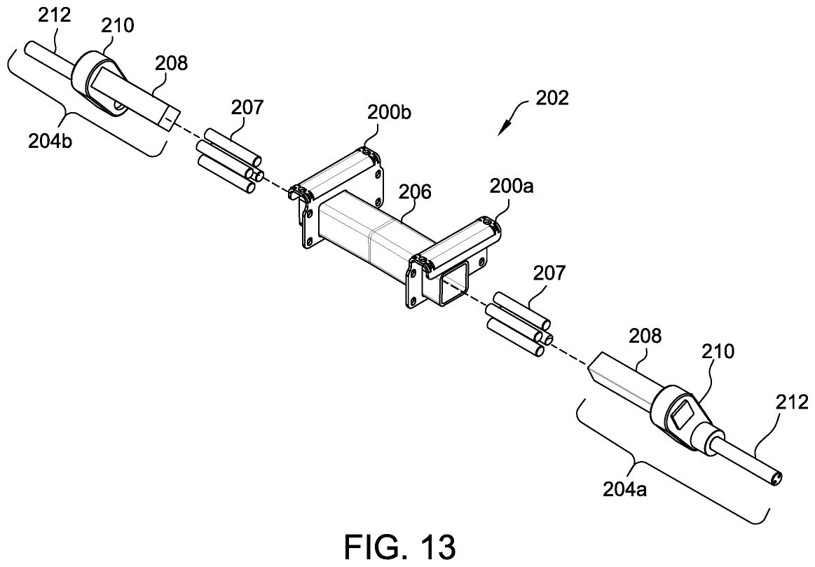

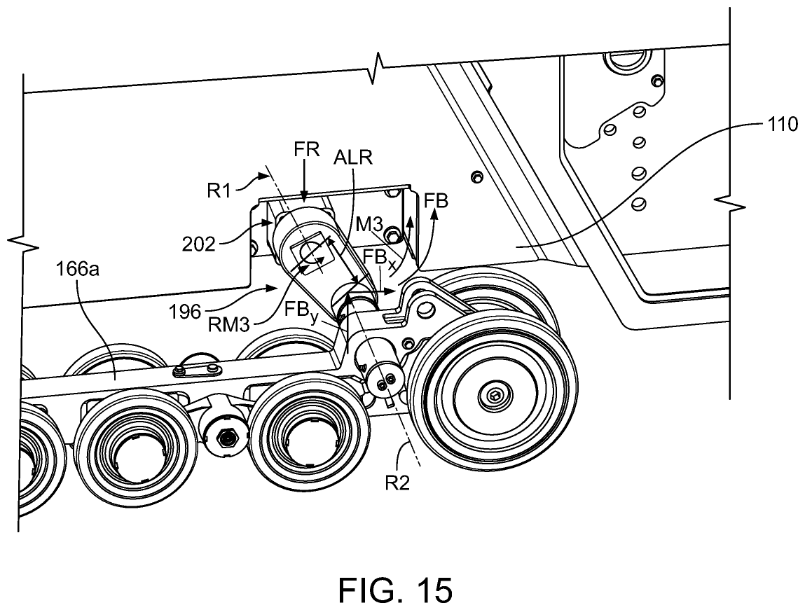

The rear suspension assembly 196 includes a rear torsion assembly 202. The front suspension assembly 194 includes a front torsion assembly 224. FIG. 13 illustrates rear torsion assembly 202 which includes outer tube 206, brackets 200a, 200b, rubber cords 207, and rear torsion axle assemblies 204a, 204b. For conciseness, only rear torsion assembly 202 is illustrated in FIG. 13, with the understanding that front torsion assembly 224 has similar corresponding parts. Referring to FIG. 13, outer tube 206 has a generally square profile. The rear brackets 200a, 200b are fixedly attached to facilitate attachment of the rear suspension assembly 196 to chassis 110, as previously mentioned. Rear torsion axle assembly 204a includes a rear torsion arm 210a, a rear torsion arm shaft 212a, and an interior bar 208a which are fixedly attached (i.e. welded) such that interior bar 208 and rear torsion arm shaft 212 and are longitudinally spaced apart on first and second ends of rear torsional arm 210 and project in opposing transverse directions relative the rear torsion arm 210. When described in reference to interior bar 208, the rear torsion arm 210 extends radially outward relative to an axis R1 (FIG. 15) through a longitudinal distance to rear torsion arm shaft 212.

Rear torsion axle assembly 204b is formed similar to 204a. Front torsion axle assemblies 226a, 226b include a front torsion arm 232, interior bar 208, and a front torsion arm shaft 234. Front torsion axle assemblies 226 are constructed similar to rear torsion axle assemblies 204.

Interior bars 208a, 208b have a square profile configured to fit within outer tube 206. Interior bars 208 are approximately half the length of outer tube 206. When the rear torsion assembly 202 is assembled, the interior bars 208a, 208b and rubber cords 207 are positioned within the outer tube 206, the rubber cords 207 creating a flexible mounting connection between the inner bar and the outer tube, with a similar assembly for front torsion assembly 224. Separate, independent torsion axle assemblies allow the left and right suspension assemblies to function independently, more specifically, 204a functions independently of 204b, and 226a functions independently of 226b.

Referring to FIG. 12, when the rear torsion assembly 202 is assembled and mounted on chassis 110, the interior bar 208, and rear torsion arm shaft 212 extend in a transverse direction (i.e., a direction that is generally perpendicular to a vertical plane defined by the longitudinal axis LA (FIG. 2) and is intended to include a few degrees of axle camber that may be present to account for deflection during loading). As mentioned, the rear torsion arm 210 extends radially outward from the interior bar 208, in a longitudinally rearward and partially downward direction, to the rear torsion arm shaft 212. The rear torsion arm shaft 212 extends transversely from the rear torsion arm 210 and into a rear shaft housing 222 of the track frame 166. The rear torsion arm shaft 212 pivotally attaches to the track frame 166a through the rear shaft housing 222 by bearings 214, 215, securing washer 216, and fasteners 218.

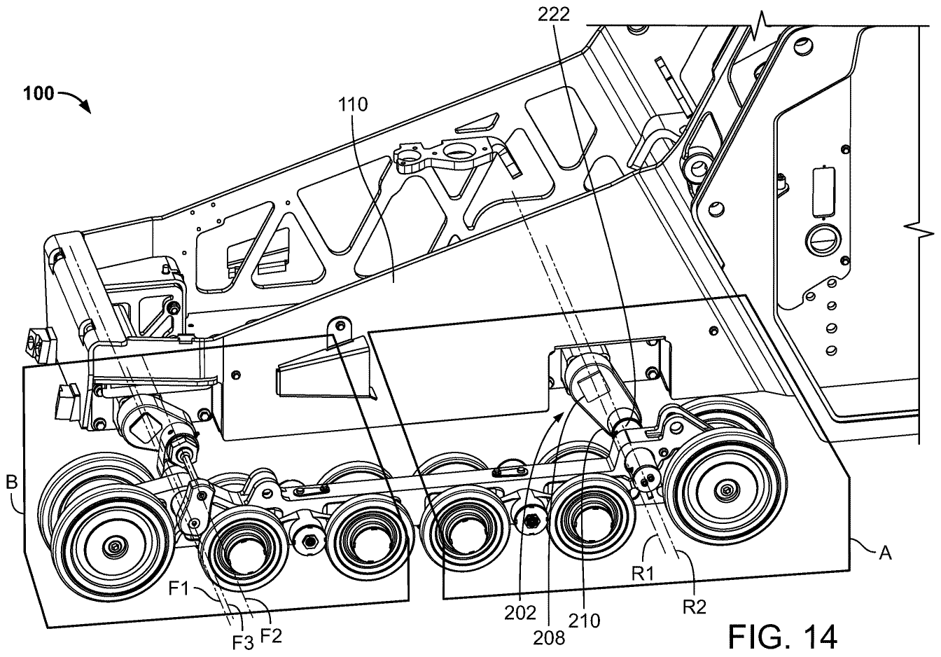

Referring to FIG. 14, a first rear axis R1 extends through the rear interior bar 208 transversely through the compact tool carrier 100. Rear torsion axle assembly 204 is configured to rotate about first rear axis R1 (by the flexible mounting arrangement between the bar 208 and the outer tube), however this motion is resisted by the rubber cords 207. A second rear axis R2 extends through the rear torsion arm shaft 212 (visible in FIGS. 14, 15). The first rear axis R1 and second rear axis R2 are generally parallel to one another. Sufficient force (describe in detail below) will cause rotation of the rear torsion arm 210 about the first rear axis R1. As the torsion arm 210 is rotated by the forces causing relative movement between the drive mechanism 125 and chassis 110, the interior bar 208 also rotates. This rotation of the interior bar 208 of rear torsion assembly 202 is resisted and dampened by the rubber cords 207, which are fixed with respect to the outer tube 206 and exert a biasing torque on the inner square bar 208 and the torsion arm 210.

Rubber torsion assemblies, such as those described in torsion assemblies 202 and 224, generally have a progressive spring rate. Progressive springs are also referred to as variable rate springs. Progressive rate springs can be defined as a spring where the spring rate changes and the spring's deflection will not be a linear relationship to the load applied. For example, progressive rate springs become can become stiffer as they are loaded, which may provide a spring that is supple enough to absorb smaller loads and vibrations, yet the increase in spring rate with increase in load allows the spring to handle larger forces. The rubber cords 207 may be selected such that torsion assemblies 202 and 224 have a different spring rate. Some example characteristics of rubber cords 207 that may result in different spring rates of the torsion assemblies 202, 224 include cord diameter, cord length, shore hardness (durometer), and rubber composition. In some embodiments alternative materials to rubber may be utilized, such as polyurethane.

Referring back to FIG. 11, the front suspension assembly 194 is substantially similar to the rear suspension assembly 196, except as described differently herein. For example, the front suspension assembly 194 includes a front torsion assembly 224 that is substantially the same as the rear torsion assembly 202, including a rubber torsion assembly having a generally progressive spring rate. However, in the example embodiment, the front suspension assembly 194 includes an additional torsion link 228 and a torsion bar 230 (FIG. 12) that connect the front torsion assembly 224 to the track frame 166a.

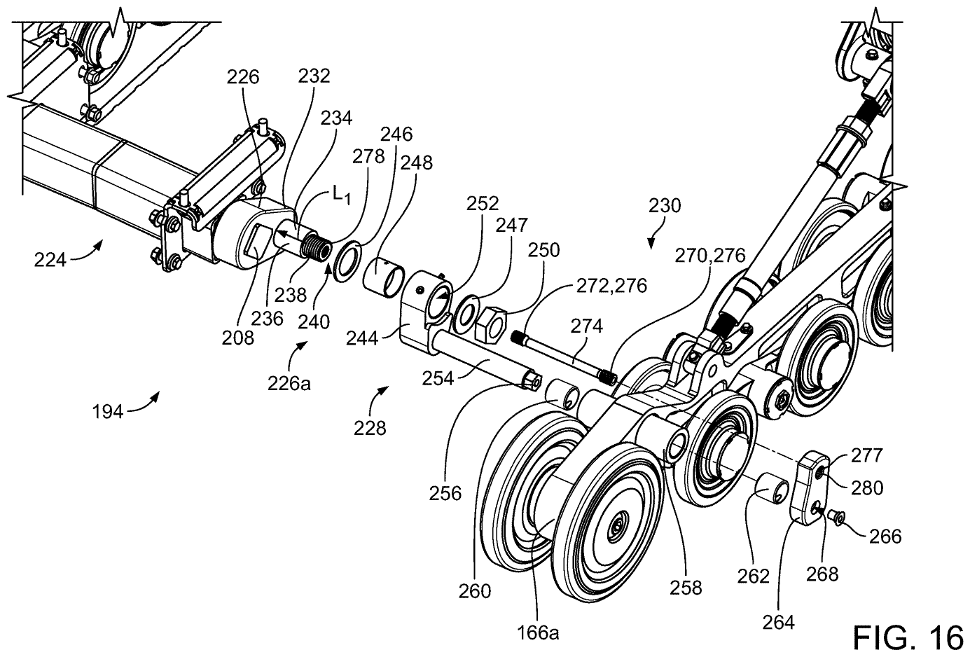

Referring to FIG. 16, when assembled, the front torsion arm 232 extends radially outward from the interior bar 208 and in a rearward and partly downward direction to a torsion arm shaft 234. The torsion arm shaft 234 extends transversely outward from the front torsion arm 232 and defines a length L1 that is less than a length (not shown) of the rear torsion arm shaft 212 provided on the rear torsion arm 210 (FIG. 12). The torsion arm shaft 234 includes a smooth portion 236 extending from the front torsion arm 232 and a threaded portion 238 extending from the smooth portion 236. The first end of torsion arm shaft 234 further defines an interior cavity 240 having an anti-rotation feature 278, such as splines, in correspondence with a second end 272 of the torsion bar 230, as described in greater detail below.

The torsion link 228 includes a torsion link arm 244 which is pivotally attached at first end to front torsion arm shaft 234 by washers 246, 247, bearing 248 and nut 250. The nut 250 restrains transverse movement of the torsion link 228 relative to the front torsion arm 232. The first end of torsion link arm 244 defines an arm opening 252 that is sized to receive the bearing 248 and smooth portion 236 of the torsion arm shaft 234 radially therein. During assembly, washer 246 is slid over torsion arm shaft 234 to contact front torsion arm 232 and the bearing 248 is slid onto the smooth portion 236 of the torsion arm shaft 234 to abut the washer 246. The torsion link 228 is slid onto the torsion arm shaft 234 and over the bearing 248. The washer 247 is then slid on the torsion arm shaft 234 to abut the bearing 248 and the nut 250 is threaded onto the threaded portion 238 of the torsion arm shaft 234.

The torsion link 228 further includes a torsion link shaft 254 that is fixedly attached (i.e. welded) to a second end of torsion link arm 244 (FIG. 16). Torsion link shaft 254 is radially spaced from the arm opening 252 of the torsion link 228 and extends transversely from the torsion link arm 244 to define a second end 256 of the torsion link 228. Second end 256 may have an anti-rotation feature, such as a hex profile. The torsion link shaft 254 pivotally attaches to the track frame 166a through the front housing 258 and is secured by a connector link 264 and the fastener 266. Connector link 264 may have a corresponding anti-rotation feature, such as a hex aperture, to receive second end 256 to prevent rotation of connector link 264 relative to torsion link 228. Bushings 260 and 262 provide a wear surface between the torsion link shaft 254 and front housing 258. Specifically, when assembled, the torsion link shaft 254 extends through the bushings 260, 262 and the front housing 258. The terms “bushings” and “bearings” are used interchangeably in this application.

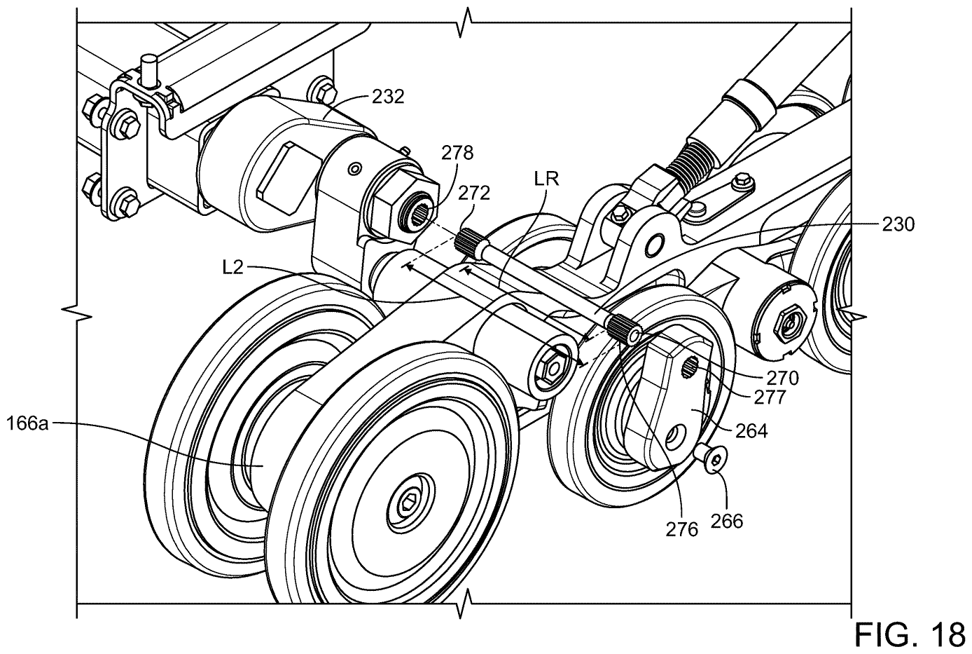

The fastener 266 extends through a lower opening 268 in the connector link 264 and into the second end 256 of the torsion link 228 to attach the torsion link 228 to the connector link 264 (FIG. 18). The torsion bar 230 includes a first end 270, a second end 272, and a body 274 extending transversely between the first and second ends 270, 272 (FIG. 16). The first and second ends 270, 272 each include anti-rotational features 276 provided on an outer circumference thereof that mate with corresponding anti-rotational features 278 (FIG. 18) on the torsion arm shaft 234 and an anti-rotation feature 277 (FIG. 18) of connector link 264 to restrain rotation of the ends 270, 272. The second end 272 of the torsion bar 230 extends into the cavity 240 of the torsion arm shaft 234 and the first end 270 extends into an upper opening 280 defined in the connector link 264.

The anti-rotational features 276 at the first end 270 rotationally fix the torsion bar 230 to the connector link 264. The anti-rotation features 276 at the second end 272 rotationally fix the torsion bar 230 to the front torsion arm shaft 234. The torsion bar 230 transfers rotational forces from front torsion arm 232 through the connector link 264 and to the torsion link 228. The torsion link 228 is pivotally attached to the front torsion arm shaft 234 and may pivot relative to the front torsion arm 232. The rotational motion of the torsion link 228 about the torsion arm shaft 234 (i.e. second front axis F2, described below) is resisted by torsion bar 230 due to the anti-rotational features 276 (and mating with the features 278 in the interior cavity 240 and the connector link 264). Any rotation of link 228 relative to torsion arm shaft 234 requires twisting of torsion bar 230. Any twisting within torsion bar 230 occurs within the body 274. In the example embodiment, the anti-rotational features are splines, though in other embodiment any suitable anti-rotational shape or connection may be used.

Torsion bars, like torsion bar 230, typically have a linear spring rate. A linear spring can be defined as a spring where the spring rate is constant regardless of the load acting on the spring and the spring's deflection will have a linear relationship to the applied force. Linear springs tend to be more stiff and may provide a more rough ride if used alone because they do not handle small loads and vibrations as smoothy as progressive springs. An advantage to linear springs is they may transfer large forces with less deflection when compared to progressive springs.

The installation of torsion bar 230 during the assembly process is another important aspect of suspension system 132. The torsion bar 230 can be installed at various times during assembly (such as before attachment of connector link 264 to torsion link 228, and/or before or after the weight of the machine is supported by the suspension system 132), however a preferred installation method comprises: (1) supporting the chassis 110 with a lifting device (such as a jack, fixture, or overhead crane) to lift the chassis 110 from the ground which gives clearance for the process of installing and securing: (1A) torsion assemblies 202, 224 to the chassis, (1B) installing torsion link 228 to front torsion assembly 224, (1C) installing track frame 166 on torsion assemblies 202, 224 (by sliding front housing 258 and rear housing 222 over torsion link shaft 254 and rear torsion arm shaft 212, respectively), (1D) installing connector 264; then (2) adjusting the lifting device such that the weight of the chassis 110 (and any components attached thereto) is supported by the components of the suspension system 132 (which may cause some rotation of torsion assemblies 202, 224, for example, in a nonlimiting example, front torsion axle assembly 224 may rotate approximately 6 degrees (angle β described in detail below), (2A) inserting (longitudinally sliding) torsion bar 230 through upper opening 280 of connector link 264 until the anti-rotation features 276 of torsion bar 230 engage the anti-rotation features 278, 277 of front torsion arm shaft 234 and connector link 264, respectively, and (2B) installing a cap or fastener (not shown) over upper end opening 280. More simply stated, torsion bar 230 may be installed near the end of the assembly process, when the weight of compact tool carrier 100 is already supported by suspension system 132.

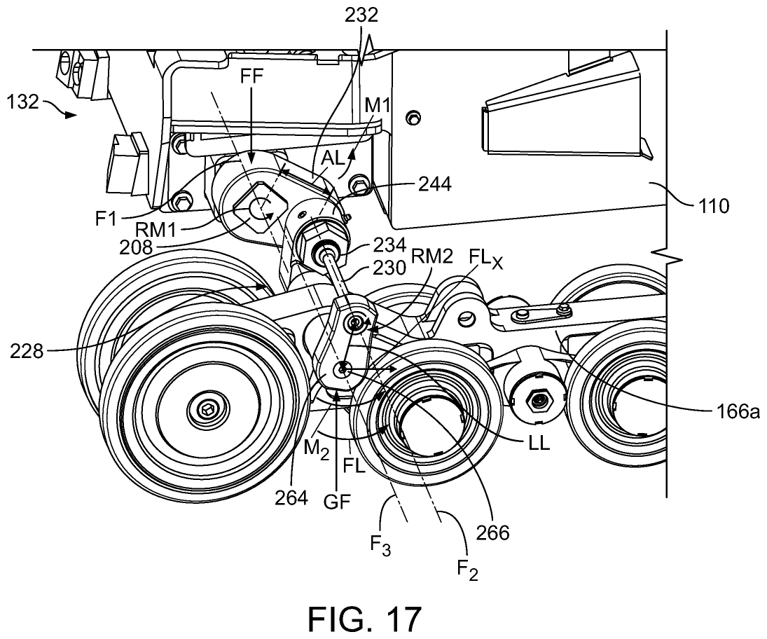

When assembled as described above, any additional load to the chassis (attachments, operator, etc.) may cause a rotational moment (RM2) to torsion bar 230 (FIG. 17), which transfers force to the rear suspension assembly 196 through track frame 166 as detailed further below. Additionally, the torsion assemblies 202 and 224 provide a progressive spring rate as forces are applied to the suspension system 132, which is used in combination with the linear spring rate of torsion bar 230 to assist in transferring forces between the front and rear suspension assemblies 194, 196.

Referring to FIG. 17, in the example embodiment, the interior bar 208 defines a first transversely extending front axis F1. The torsion bar 230 defines a second front axis F2 extending through the first and second ends 270, 272 (FIG. 16) of the torsion bar 230, The torsion link shaft 254 defined a third front axis F3. Each of the front axes F1-F3 are generally parallel to one another.

As mentioned, the front interior bars 208a, 208b are fixedly attached to one end of front torsion arm 232a, 232b. Sufficient force (enough to cause relative movement between the drive mechanism 125 and chassis 110) at the second end (where front torsion arm shaft 234 is mounted) of front torsion arm 232 will cause rotation of the front torsion arm 232 about the front axis F1. As the torsion arm 232 is rotated the interior bar 208 also rotates. This rotation of the interior bar 208 of front torsion assembly 226 is resisted and dampened by the rubber cords 207, which are fixed with respect to the outer tube 206 and exert a biasing torque on the inner square bar 208 and the torsion arm 232.

When torsion link 228 is assembled as described above and shown in the figures, the torsion link 228 can rotate about front axis F2 by the pivotal connection to front torsion shaft 234, however this rotation is resisted and dampened by torsion bar 230 (FIG. 17). Torsion link 228 can also rotate about axis F3.

The primary purpose of the rubber torsion assemblies 202, 224, is to provide cushioning and dampening of shock and vibration while working in cooperation with torsion bar 230 to utilize forces to adjust the vertical distance from the chassis to the ground dependent on the degree of rotation of the torsion elements 202, 224, 230.

To appreciate the functionality of drive mechanism 125, the front and rear suspension assemblies must be considered together, as they are configured to cooperate to distribute forces and maintain a generally consistent pitch of the chassis 110 regardless of if the compact tool carrier is loaded or unloaded. The forces to be distributed may include the weight of the machine, weight of the operator, weight of the attachment, the weight of a load in or on the attachment, propulsion of the machine, variations in the terrain (bumps, rocks, etc.) or any combination of the aforementioned. When loaded, the ground clearance (i.e., the distance between chassis 110 and a ground on which the drive mechanism 125 rests) is decreased from the unloaded condition while the pitch of the chassis 110 is maintained generally consistent. More specifically, the torsion suspension elements 202, 224, 230 of the front and rear suspension assemblies 194, 196 are interconnected in a series such that forces transferred through the drive mechanism 125 may affect the deflection (motion) of the torsion elements 202, 224, 230. The components of the drive mechanism 125 must be selected such that expected loads (ranging from an unloaded condition, loaded condition, to a breakout condition-all of which are described below) do not exceed the mechanical limits of the components.

As a non-limiting example, if the allowable rotation of the rubber torsion elements 202, 224 may not exceed 22.5 degrees of rotation (referring to the rotation of interior bar 208 within outer tube 206 from an unloaded position) before a mechanical failure occurs, and when including a safety factor, the spring rate and sizing of components maybe be selected to not exceed 20 degrees of rotation under expected loading conditions. The rubber torsion elements 202 and 224 may be configured to have different properties (different sizes and/or spring rates when compared to each other). Similarly, as a non-limiting example, if allowable rotation of the torsion bar 230 may not exceed 12 degrees of rotation (relative axial rotation of first end 270 compared second end 272) before a mechanical failure occurs, and when a safety factor is included, the spring rate and sizing of the torsion bar 230 maybe be selected to not exceed 10 degrees of rotation under expected loading conditions. Additionally, the configuration (particularly the length) and positioning of the arms (210, 232, 224) affects the load experienced by the drive mechanism components and must correspond and cooperate with selection of the torsion elements to not exceed mechanical limits of the drive mechanism components.

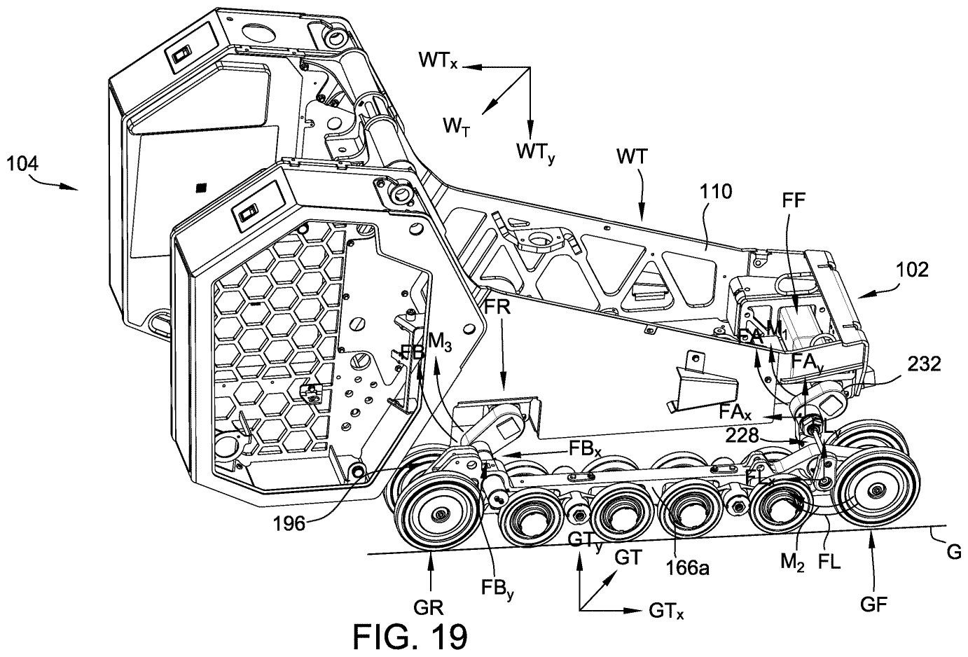

FIGS. 15, 17, 19, and 20 include schematic force diagrams showing interaction of forces between the chassis 110 and drive mechanism 125, which includes the suspension system 132. Referring to FIG. 19, a weight force WT represents net force acting on the chassis 110. For example, the weight force WT may include the machine weight, the weight of the operator, and any additionally forces created during use, such as pushing or pulling a load (with the loader arms), and loads from the loader arm attachment (such as a bucket full of a material, i.e. soil). The weight force WT is shown as vertical in FIG. 19 for schematic purposes, though it should be understood that the weight force WT may be angled or negative. Also shown are dimensional components of the weight force WT, including horizontal force component WTx and vertical force component WTy. The weight force WT passes through the chassis 110 to the drive assemblies 124 (including suspension assemblies 194, 196), which is supported by the ground G. The weight force WT is distributed to the front 102 and rear 104 of the compact tool carrier 100. The front force FF represents the portion of the weight force WT distributed to the front suspension assembly 194 of the compact tool carrier 100 and the rear force FR represents the portion of the weight force WT distributed to the rear suspension assembly 196 of the compact tool carrier 100. The weight force WT is counteracted by a ground force GT which can also be broken into X and Y components GTx and GTy, and front and rear forces GF and GR, respectively.

As detailed in the following paragraphs, forces due to loading and unloading of the suspension components may create motion M1 of the front torsion axle assembly 226 (FIG. 17). Motion M1 creates a change in the angular orientation (described in detail below) of front torsion arm shaft 234. The change in angular orientation creates a rotational moment RM2. Rotational moment RM2 transfers through torsion link 230 and contributes to force FL (FIGS. 17, 19) at the second end of connector link 264. A portion of force FL, represented as FLx, is transferred to the rear suspension assembly through track frame 166, and thereby contributes to rotational moment RM3 (FIG. 15) by partially contributing to force FB, represented as FBx. Thereby, a front force FF on drive assemblies 124, which may include load WL on tool 122 (FIG. 15), that shifts the center of gravity of compact tool carrier 100 forward (which creates unloading of the rear axle) will lower the rear chassis through a transfer of forces creating motion M3 (FIG. 15), with the objective of maintaining a consistent chassis pitch, despite the forward shift in the center of gravity, which would reduce the rear force FR.

As mentioned, forces applied to the drive mechanism 125, such as the static weight and usage of compact tool carrier 100, cause loading and unloading of compact tool carrier 100. Referring to the front suspension assembly 194 as shown in FIG. 17, the front force FF is translated from the chassis 110 to the front torsion assembly 224 (FIG. 16) due to the attachment through the front brackets 198 (FIG. 11). The front force FF on the front torsion assembly 224 generates a first rotational moment RM1 (FIG. 17) along the first front axis F1. The forces may create rotational motion M1 of the front torsion arm 232 about front axis F1 due to force FA (FIG. 19). Force FA is a result of WT, specifically FF, and reactionary forces from ground G. The amount of motion M1 is dependent on the amount of forces FF, the reactionary force from ground G, and is resisted by the torsional resistance (spring rates) of the torsion elements 202, 224, and 230. The rotational moment RM1 is based on the radial length AL of the front torsion arm 232 and the amount of force FA applied to the front torsion arm 232 at axis F2. The radial length AL is defined as the distance between a center point of the interior bar 208 that is coincident with the first front axis F1 and a center of the front torsion arm shaft 234 that is coincident with second front axis F2.

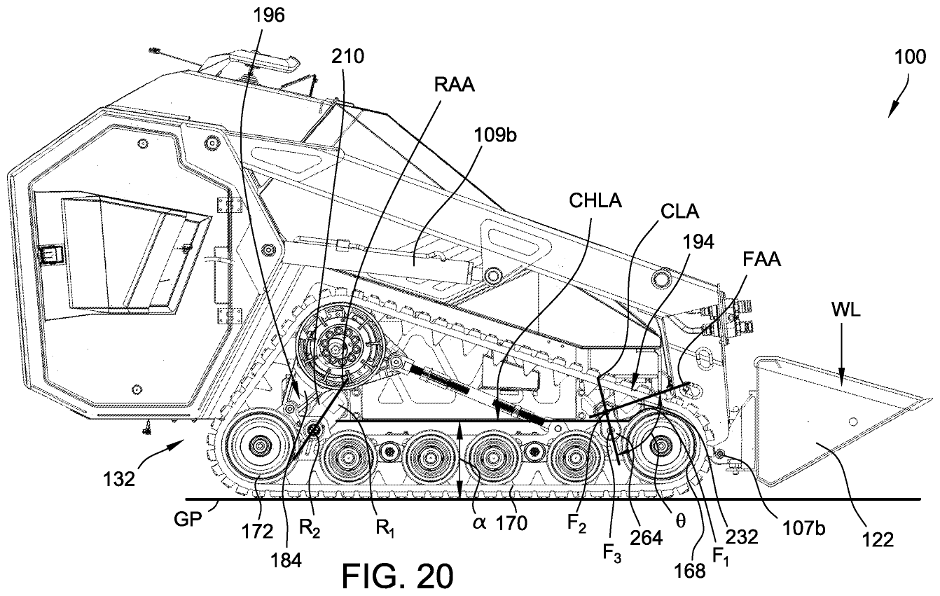

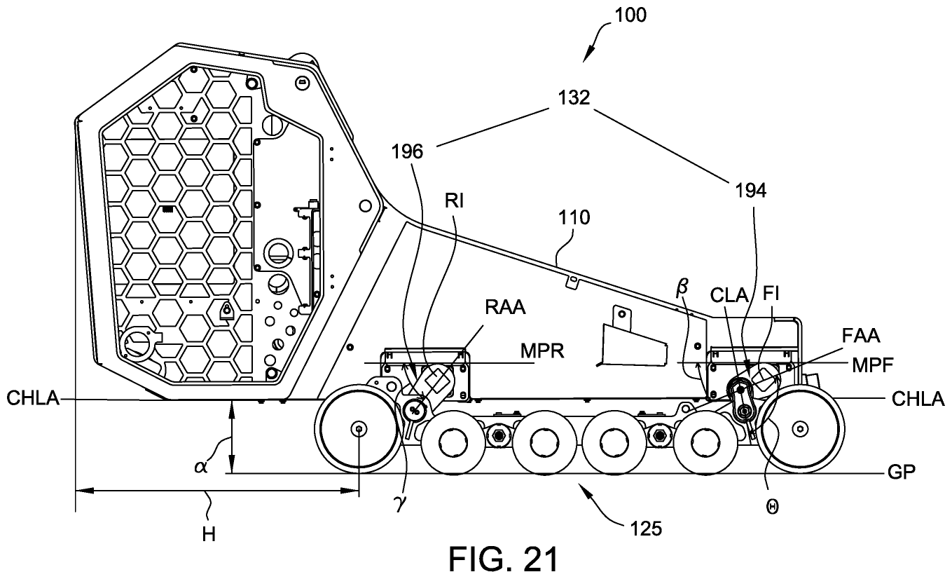

Motion M1 causes the angular orientation of front torsion arm axis FAA (FIG. 20) of the front torsion arm shaft 234 to change relative to the front mounting plane MPF (FIG. 21), represented as first angle β. Front mounting plane MPF is generally coplaner with the top surface of the outer tube of torsion assembly 224. The front torsion arm axis FAA extends along the length AL of the front torsion arm 232 through the first front axis F1 and the second front axis F2. Also referenced in FIG. 20 is ground plane GP which is a plane extending along the ground surface supporting the compact tool carrier 100. The ground plane GP is shown as a flat plane for illustration. In practice, the ground plane GP may be inclined or uneven. The ground plane GP may also be characterized as a plane that is tangent to two or more of the rollers 168, 170, 172.

Due to the anti-rotational attachment of torsion bar 230 to front torsion arm 232, an angular change in β of FAA due to motion M1 creates an equivalent rotation of the second end 272 of torsion bar 230 (FIG. 17) relative to the front mounting plane MPF (FIG. 21). The rotational force from second end 272 of torsion bar 230 travels through the body 274 to first end 270 (FIG. 16), creating rotational moment RM2 along the second axis F2 at first end 270. The magnitude of the rotational moment RM2 is at least partially based on the spring rate of torsion bar 230 and the corresponding reactionary forces transferred from the ground G through the connector link 264 by the track frame 166 and torsion link 228.

Rotational moment RM2 is converted to force FL (FIG. 19) through the connections of connector link 264 to torsion link 228. Resultant force FL is at least partially based on link length LL and rotational moment RM2. The link length LL is a partial length of the connector link 264 as measured by the distance between the center point of front torsion arm shaft 234 or torsion bar 230 (coincident with axis F2) and a center of the torsion link shaft 254 (FIG. 16) (coincident with axis F3). The connector link 264 is attached to and transfers forces to torsion link shaft 254, which transfers forces to the track frame 166a. Force FL is then transferred to track frame 166 through the pivotal connection of torsion link 228 to track frame 166. A portion of force FL, represented as FLx (FIG. 19), is transferred through track frame 166 to the rear suspension assembly 196, which is detailed below.

Rotational moment RM2 may result in motion M2 (shown counter-clockwise in FIG. 17) of torsion link 228 about axis F2 causing the angle of connector link axis CLA (FIG. 20) of the connector link 264 to change relative to front torsion arm axis FAA. The connector link axis CLA extends along the length LL (FIG. 17) of the connector link 264 and through the second front axis F2 and the third front axis F3. Second angle θ represents the angle of connector link axis CLA relative to front torsion arm axis FAA.

The amount of motion M2 is at least partially dependent the amount of forces WT, the reactionary force from ground G, and is resisted by the torsional resistance of the torsion elements 202, 224, and 230.

Due to reactionary forces causing rotational deflection of torsion bar 230, the amount of rotation of the second end 272 of torsion bar 230 may not match the rotation of the first end 270. The torsional resistance and degree of axial rotation of the torsion bar 230 is based on the material, shape, cross section, and length of the torsion bar 230. The torsion bar 230 is rotationally restrained only at the first and second ends 270, 272 (FIGS. 16, 18), allowing for rotation in the bar over the length of the body 274 when the suspension system 132 is loaded. As shown in FIG. 18, the torsion bar 230 has a length L2 and a working length LR. The working length LR is the portion of the bar (i.e., the body 274 (FIG. 16)) where torsional rotation occurs between the anti-rotational features 276 at the first and second ends 270, 272.

FIG. 15 illustrates forces on the rear suspension assembly 196 and motion M3 in response to ground force GF. Rear force FR represents the portion of the weight force WT distributed to the rear suspension assembly 196 of the compact tool carrier 100. Rear force FR is translated from the chassis 110, to the rear torsion assembly 202, which creates a portion of rotational moment RM3 about axis R1. The rear force FR may be a portion of the static weight of the machine. The rear force FR may be reduced when an attachment or load, such as WL, causes the center of gravity of the compact tool carrier 100 to shift forward. In prior art machines this may cause the rear end to raise and front end to lower, resulting in a “nose down” pitch of a machines, which may be uncomfortable for an operator, and lead to some operational limitations (reduced lift height). As mentioned earlier, in certain loading conditions a portion of the force FLx from the front suspension assembly 194 is transferred through the track frame 166 and affects the force FB (primarily FBx) which contributes to rotational moment RM3 acting on the rear suspension assembly 196. The magnitude of force FLx is partially dependent upon the loading conditions of the machine.

The forces of rotational moment RM3 may create motion M3 (shown counter-clockwise in FIG. 15) of rear torsion arm 210 about axis R1 causing the angle of rear torsion arm axis RAA (FIGS. 20 and 21) of the rear torsion arm 210 to change relative to the rear mounting plane MPR. Rear mounting plane MPR is generally coplaner with the top surface of the outer tube 206 of torsion assembly 202. The rear torsion arm axis RAA extends along the length ALR (FIG. 15) of the rear torsion arm 210 and through the first rear axis R1 and the second rear axis R2. The rear torsion arm axis RAA is oriented relative to the rear mounting plane MPR at a third angle γ. The magnitude of the third rotational moment RM3 is based on the rear arm length ALR and the force FB on the rear torsion arm shaft 212 which is attached to and transfers forces from the track frame 166a. The rear arm length ALR is the length of the rear torsion arm 210 as measured by the distance between the center point of the interior bar 208 (coincident with axis R1) and the center of the rear torsion arm shaft 212 (coincident with axis R2). The motion of the rear torsion arm 210 is shown by the direction arrow M3 (FIG. 19). The amount of motion M3 is dependent on the amount of force FR, the reactionary force from ground G, and is resisted by the torsional resistance (spring rates) of the torsion elements 202, 224, and 230.

As described above, the components of the front and rear suspension assemblies 194, 196 are effectively tied together in series which results in a stiffening of the suspension system under certain loading conditions, such as a weight WL on tool 122. An objective of this configuration is to transfer a portion of the front force FF from the front suspension assembly 194 to the rear suspension assembly 196. An additional objective of suspension system 132 is maintaining a relatively consistent pitch of chassis 110 regardless of the loading from tool 122. The spring rate of the torsional suspension components (specifically rear torsion assembly 202, front torsion assembly 224, and torsion bar 230) must be selected to cooperate such that loading forces result in deflection rates that maintain a generally consistent pitch of the compact tool carrier. Additionally, the supporting components (such as torsion arms 210, 234, and torsion link 228) must be configured such that the motion of components works in cooperation with the spring rates to accomplish the above-mentioned objectives.

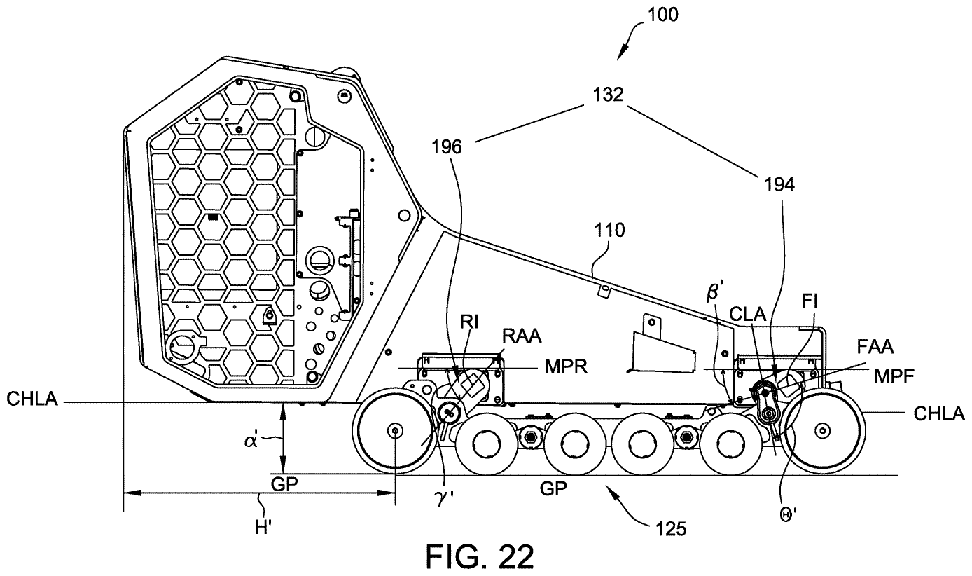

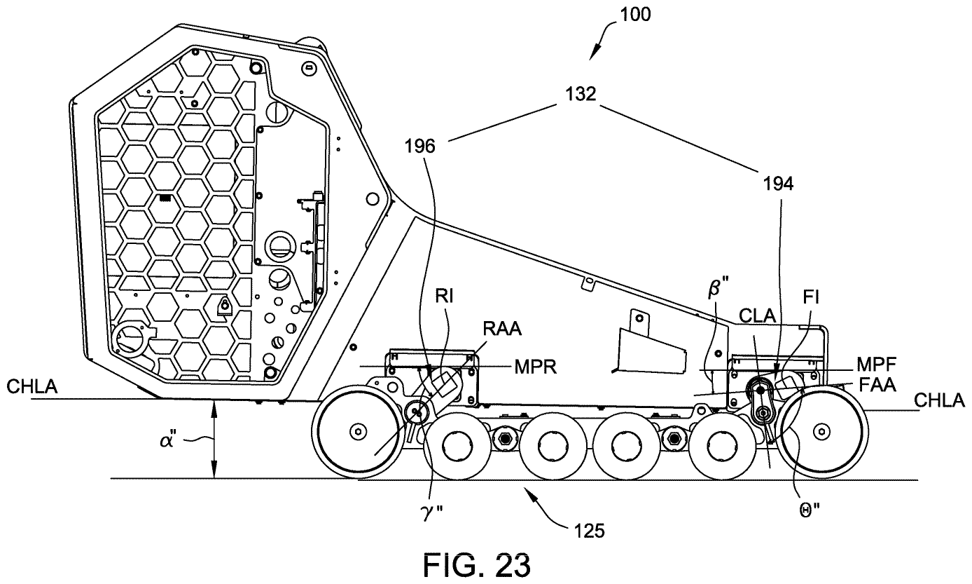

To illustrate, three different load conditions of the compact tool carrier 100 are described herein with tool 122 (see FIG. 1) as a material handling bucket. FIG. 21 illustrates an example positioning of suspension system 132 (see FIG. 12) in an unloaded condition, where the tool 122 is empty and the compact tool carrier 100 is at rest and only the static weight of compact tool carrier 100 is supported by suspension system 132. FIG. 22 illustrates and an example position of the suspension system 132 in an expected load condition, such as at a rated operating capacity of compact tool carrier 100, e.g. where the tool 122 is loaded with material such as soil. Lastly, FIG. 23 illustrates a maximum load configuration, the tool 122 is in a “breakout condition” where tool 122 is trying to lift an immovable object or fastened to the ground, creating forces exceeding the rated operating capacity. FIGS. 21, 22, and 23 are shown for example purposes and are not limiting configurations.

FIGS. 21, 22, and 23 show connector link axis CLA, front torsion arm axis FAA, rear torsion arm axis RAA, a chassis level axis CHLA (alternatively referred to as a “chassis pitch” axis), a front mounting plane MPF, a rear mounting plane MPR, and a ground plane GP. The chassis level axis CHLA extends along the bottom of the chassis 110, generally parallel to the front and rear mounting planes MPF, MPR in the illustrated embodiment of FIGS. 21-23. The example values in FIG. 21 (unloaded condition) are represented by the designated identifier, such as a, the example values in FIG. 22 (loaded condition) are represented by the designated identifier plus a “′” symbol, such as “α′”, and the example values in FIG. 23 (breakout condition) are represented by the designated identifier plus “″” symbol, such as “α″”.

Referring to FIGS. 21, 22 and 23, when sufficient forces on the front suspension assembly 194 cause deflection of torsion assemblies 202, 224, and 230, the front torsion arm 232 rotates clockwise, as shown by arrow M1 (FIG. 17), which reduces the first angle β when comparing FIG. 21 through FIG. 23. The starting position (not shown) of first angle β may be 29 degrees. The starting position is referring to the condition where no load is on the suspension system 132, such as during assembly when the chassis is supported by other means, such as blocks, fixtures, or jacks. FIG. 21 shows an unloaded condition with first angle β of about 23 degrees. FIG. 22 shows a loaded condition with first angle β′ of about 16 degrees. In the maximum load condition of FIG. 23 the first angle β″ may be about 10 degrees.

Again, comparing the unloaded and loaded conditions of FIGS. 21 through 23, the connector link 264 may also rotate (motion M2, FIGS. 17 and 19) with the front torsion arm 232 due to the rotationally resistant connections of torsion bar 230, thereby changing the second angle θ. Second angle θ may range from about 100 degrees in the unloaded condition of FIG. 21, about 92 degrees in the loaded condition of FIG. 22, and about 90 degrees in the breakout condition of FIG. 23. Second angle θ reflects the axial angular deflection of torsion bar 230. When torsion bar 230 is installed after the static weight of the machine is supported by the suspension system 132 (as described above) the axial angular deflection in the unloaded condition of FIG. 21 is zero. Based on the second angle θ′ in the example loaded condition of FIG. 22, the axial angular deflection of torsion bar 230 may be about 8 degrees. Finally, angle θ″ of on the breakout condition of FIG. 23 shows an axial angular deflection of torsion bar 230 of about 10 degrees.

Regarding the third angle θ of the rear suspension assembly 196, the starting position (not shown) of Γ may be 63 degrees. The third angle Γ in the unloaded condition of FIG. 21 may be about 49 degrees. Motion M3, caused by the forces of loading, increases the third angle γ, because the center of gravity is shifted forward, thereby unloading the rear suspension assembly. The third angle γ′ in the loaded condition of FIG. 22 may be about 51 degrees. The third angle γ″ in a maximum load condition of FIG. 23 may be about 49 degrees. When a load is removed from compact tool carrier 100, the components of suspension system 132 move back toward the unloaded positions shown and described in relation to FIG. 21.

The chassis level axis CHLA is referenced relative to the ground plane GP to determine a pitch angle α (FIGS. 20, 21, 22, 23). The pitch angle α characterizes a relative orientation of the chassis 110. For example, when the pitch angle α is positive, the chassis 110 is in a “nose-up pitch”. When the pitch angle α is negative, the chassis 110 is in a “nose-down pitch”. When the pitch angle α is zero (i.e., when the chassis level axis CHLA is parallel to the ground level axis), the chassis 110 is at a “level pitch”.

The suspension system 132 of the present disclosure is configured to reduce changes in pitch based on varying loads on the chassis 110, while also damping loads on the chassis 110. That is, the suspension system 132 allows for varying loads on chassis 110 without resulting in large changes to the pitch angle α. For example, the loaded condition shown in FIG. 22, the pitch angle α′ is approximately −2.1 degrees, which from the perspective of an operator on the carrier 100, is considered substantially close to zero for the purposes of this disclosure. Similarly, when unloaded (FIG. 21), the pitch angle α is approximately 0.7 degrees, which is considered substantially close to zero. In a maximum load configuration of FIG. 23 the pitch angle α may be −3.2 degrees. In the example configurations shown in FIGS. 21 and 22, excluding the maximum load configuration of FIG. 23, the possible operating range of compact tool carrier will be at a pitch angle α of between 0.7 degrees to −2.1 degrees. That is, the suspension system 132 is configured to have a variance of pitch angle α between the loaded condition and unloaded condition of less than approximately six degrees, four degrees, or two degrees.

Stated another way, the vertical displacement of the front of the chassis relative to the rear of the chassis is nearly equivalent when loaded or unloaded. For example, the vertical distance from ground plane GP to R1 may be 11.8 inches when loaded and 9.6 inches when unloaded, and a vertical distance from ground plane GP to F1 may be 9.2 inches when loaded and 10.4 inches when unloaded. Therefore, the chassis remains at substantially the same pitch when loaded or unloaded when the load on the tool 122 is within the rated operating capacity. In general, in a loaded condition, the chassis will be closer to the ground plane compared to an unloaded condition.

An additional effect of movement of suspension system 132 caused by loading and unloading of compact tool carrier 100 is a change in the longitudinal distance between a vertical plane on the chassis relative to a vertical plane on the track frame 166. This longitudinal distance is represented by dimension H illustrated in FIGS. 21 and 22. Dimension H is a slight shift in the chassis when loaded versus unloaded due to the configuration of suspension system 132 and the fixed distances between the mounting locations of the front suspension system 194 and rear suspension system 196 to the chassis 110 and track frame 166. In FIGS. 21 and 22, dimension H is measured from a vertical plane extending downward from the rear of the chassis 110 to a vertical plane extending downward from the axis of rear idler roller 170 on track 166. An example of the maximum change in dimension H compared to H′ is about 1.6 inches.

When downward force is applied to the attachment plate 135 (WL in FIG. 15), such as the weight of a tool 122 or a load in the tool 122 (such as a bucket of material), the weight force WT is increased and the distribution of weight force WT is greater on the front suspension 194 (FF) relative to the rear suspension assembly 196 (FR). As a result, the center of mass of the carrier 100 shifts forward toward the front suspension assembly 194. That is, the distribution of the weight force WT on the compact tool carrier is moved forward toward the front of the compact tool carrier 100, when the compact tool carrier 100 is loaded (i.e., when the carrier 100 is loaded beyond a net weight of the carrier 100) compared to when it is unloaded. If the front suspension assembly 194 were similarly configured as the rear suspension assembly 196 (i.e., without connector link 264 and torsion bar 230) the increased force on the front suspension assembly 194 would cause the first front axis F1 to lower at a greater amount relative to the first rear axis R1, thereby causing an increased change in the pitch angle α when the compact tool carrier 100 is loaded. However, the configuration of suspension system 132 provides for rotation of front torsion arm 232 which creates a rotational moment to torsion bar 230 that translates to forces through connector link 264, a portion of these forces travel through track frame 166 and contribute to the rotational moment of rear torsion arm 210 to maintain a relatively consistent pitch angle α between the loaded and unloaded configurations, thereby providing a dampened suspension to the compact tool carrier 100 while counteracting the increased forces on the front suspension assembly 194 when loaded to maintain a consistent pitch of the compact tool carrier 100.

The forces described herein focus on the portion of forces is transferred between the components of suspension system 132 with the understanding that all forces WT are eventually transferred to ground G, for example, this disclosure does not detail all the vertical and horizontal forces transferred through the suspension assemblies to the ground. Additionally, the suspension system described herein allows for operation of the carrier 100 without the torsion bar 230 installed. For example, the torsion bar 230 may be removed to adjust the ride quality provided to the operator.

### Serviceability and Accessibility

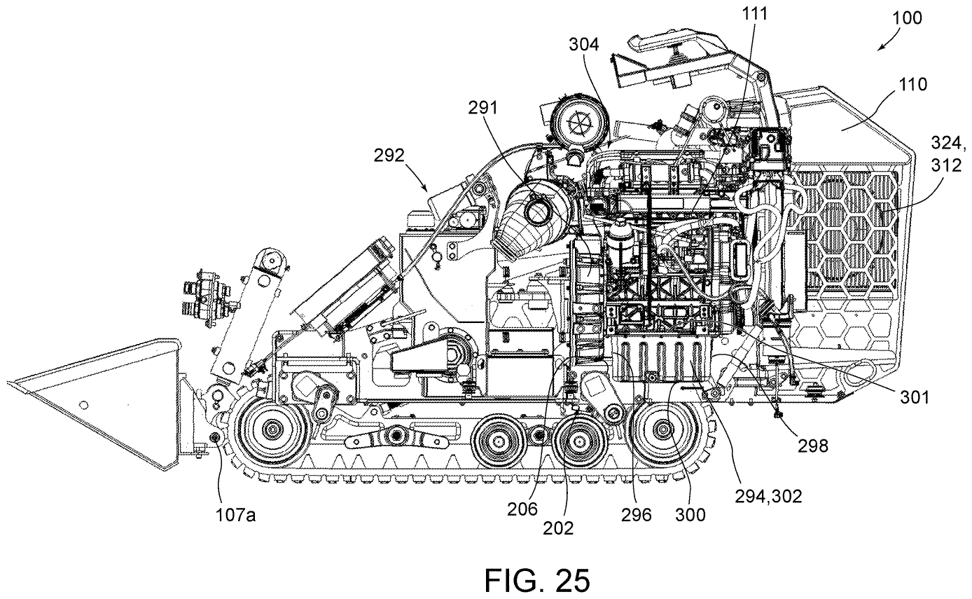

FIG. 24 is a perspective view of compact tool carrier 100 showing loader arms 112a, 112b, upper hood 284, and lower hood 286 in raised positions. A firewall 288 of the compact tool carrier 100 is shown isolated from the chassis 110. FIGS. 25 and 7 each show side views of the compact tool carrier 100 with portions removed to reveal internal components of the compact tool carrier 100.

Referring to FIG. 24, the chassis 110 lower hood 286, upper hood 284, firewall 288, and bottom plates 287 collectively define an internal engine compartment 304 and an internal hydraulic compartment 292 of the compact tool carrier 100. Engine compartment 304 and hydraulic compartment 292 are referred to as “compartments” but may not have structure (i.e., a wall or member) creating separation, these “compartments” are more like general zones or regions. The firewall 288 is configured for removable attachment to the operator station 114, though in other embodiments, the firewall 288 may be directly attached to and/or integrated with the chassis 110. The firewall 288 serves as a protective barrier between the engine compartment and operator stations 114 and serves as a shield that reduces noise from the engine 111 at the operator station 114.

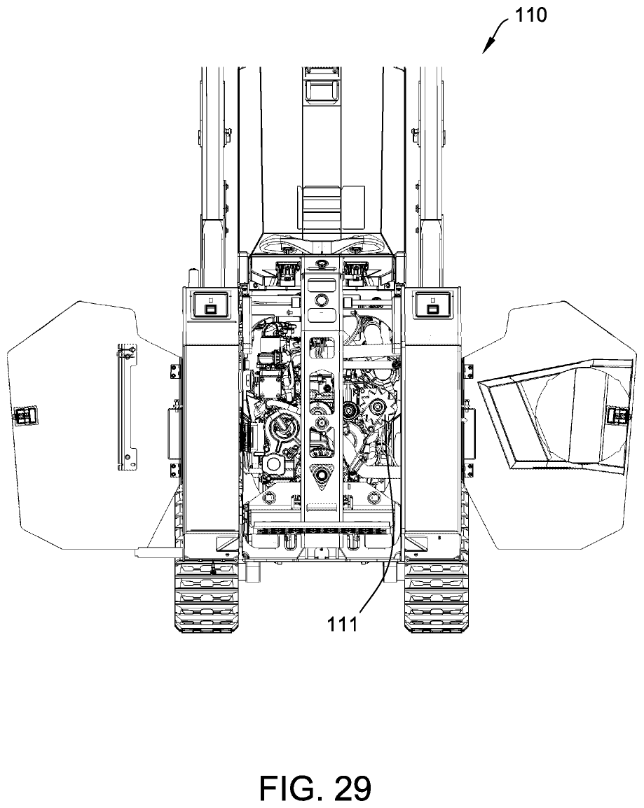

In the illustrated embodiment, the firewall 288 is removably connected on the operator station 114 and may be selectively removed, to provide access to the engine 111 and/or components of engine 111, (as shown in FIG. 29), such as an alternator, engine belt, or other components of the engine 111. The bottom plates 287 are removably attached to the chassis 110 by fasteners (not shown) and may also be selectively removed to provide access to an underside of the hydraulic compartment 292 and/or engine compartment 304, as shown in FIG. 25. For example, a technician may access the oil pan 294 (FIG. 19) or an oil drain plug (not shown) by removing the bottom plates 287.

### Engine Placement

Referring to FIGS. 25 and 7, the engine 111 is configured to drive a hydraulic pump or pump stack 290 (FIG. 7) which powers hydraulic motors (not shown), and which in turn each drive a respective one of the drive assemblies 124a, 124b. The hydraulic pump stack 290 may include a plurality of pumps that are powered by the engine 111 and provide hydraulic power to various components of the machines, such as pumps to drive the ground drive assemblies 124a, 124b, pumps to power the loader arms 112a, 112b, loader tilt actuator 136, and pumps to power auxiliary hydraulics. A flywheel (not shown) is coupled to the engine 111 and provided within a flywheel housing 291 positioned within the engine compartment (FIG. 17). Hydraulic tanks 289 or “hydraulic reservoirs” are provided for storing and cycling of a hydraulic fluid. The pump stack 290 and tanks 289 are each provided within the hydraulic compartment 292 of the compact tool carrier 100 and are positioned forward of the engine 111.

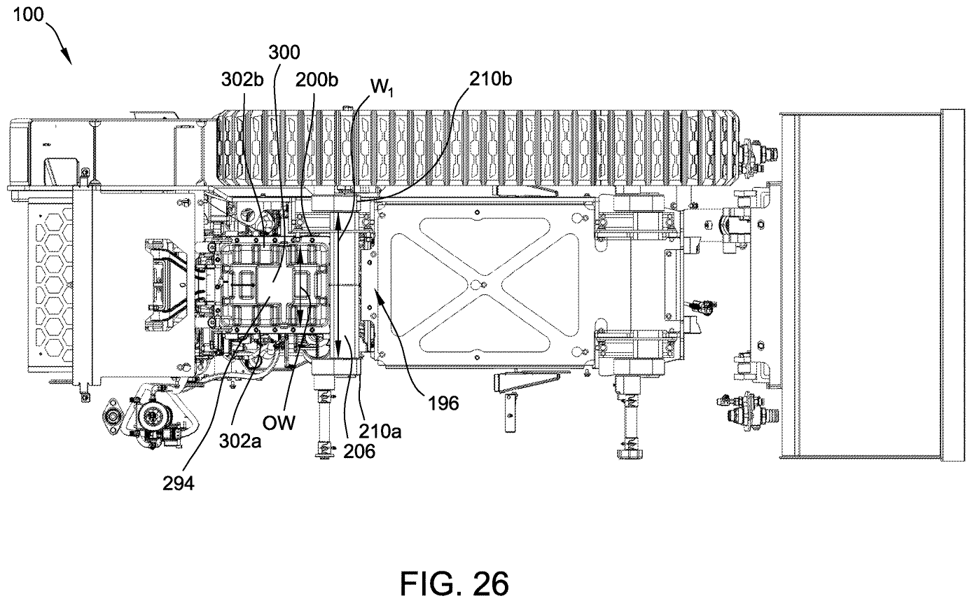

An oil pan 294 is mounted at a lower portion of engine 111 (FIGS. 25 and 26). The oil pan 294 provides a reservoir for oil that is pumped throughout the engine 111 to lubricate, clean and cool moving parts (not shown). The oil pan 294 includes a front face 296, a rear face 298, a bottom side 300, and sidewalls 302 extending upward from the bottom side 300 and longitudinally between the front and rear faces 296, 298. In the illustrated embodiment, the front and rear faces 296, 298 and sidewalls 302 of the oil pan 294 extend generally vertically upward from the bottom side 300, though in other embodiments one or more of the faces 296, 298 or sidewalls 302 may have a sloped or angled shape. The oil pan 294 further includes a flange 301 defining a top rim of the oil pan 294 that extends around the pan 294 to facilitate attachment to the engine 111.

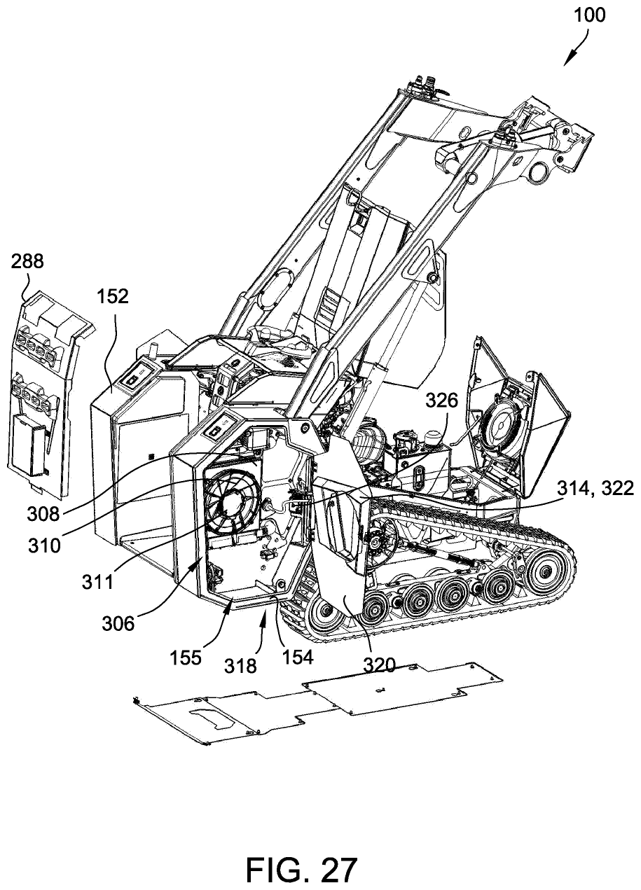

The engine 111 is provided within an engine compartment 304 and is positioned adjacent to (e.g., within less than a foot of) the firewall 288 and operator station 114 (FIG. 24). Specifically, the engine 111 and oil pan 294 are each positioned at a rearward position of the chassis 110 and extend at least partially within the gap defined between first and second compartment frames 152, 154 (FIG. 27). For example, as described above, the oil pan 294 is positioned directly beneath the engine 111. Moreover, at least a portion of the front face 296 of the oil pan 294 is positioned longitudinally rearward of the outer tube 206 of the rear torsion assembly 202 (FIG. 25). In an example configuration the oil pan 294 does not extend longitudinally forward of any point of the outer tube 206 of the rear torsion assembly 202 (alternatively referred to herein as a “rear axle” of the compact tool carrier). In another example configuration only the flange 301 of oil pan 294 extends longitudinally forward of outer tube 206. In yet another configuration, the bottom side 300 does not extend forward of any point of the outer tube 206. In the example embodiment, the bottom side 300 is positioned below a highest point of the outer tube 206 and vertically above a lowest point of the outer tube 206. In other embodiments, the oil pan 294 has a reduced overall height such that the bottom side 300 is positioned vertically above a highest point of the outer tube 206 of the rear torsion assembly 202 (e.g., as shown in FIG. 7). In yet further embodiments, the bottom side 300 of the oil pan 294 can be positioned vertically below or level with the outer tube 206 of the rear torsion assembly 202.

FIG. 26 shows a bottom view of a portion of compact tool carrier 100, with components removed to show a position and size of the oil pan 294 relative to the rear suspension assembly 196. As shown in FIG. 26, the oil pan 294 defines a transverse width OW defined as the distance between the opposed sidewalls 302a, 302b of the oil pan 294. The rear suspension assembly 196 defines a first width W1 defined as the transverse distance between the first and second rear torsion arms 210a, 210b or the transverse length of the outer tube 206 of the rear torsion assembly 202 (substantially the same in the illustrated embodiment). The rear suspension assembly 196 further defines a second width W2 (shown in FIG. 11), defined as the transverse distance between the rear brackets 200a, 200b. In the illustrated embodiment, the oil pan width OW is less than both the first width W1 and the second width W2 of the rear suspension assembly 196. Moreover, the oil pan 294 is transversely positioned within the first and second widths W1, W2 of the rear suspension assembly 196. Alternatively, at least a portion of the oil pan sidewalls 302 do not extend transversely beyond either the first width W1 or the second width W2.

The rearward position of the engine 111 improves stability and a load carrying capacity of the compact tool carrier 100. For example, the rearward position of the engine provides a rearward center of gravity of the compact tool carrier 100. As a result, counterweight kits on the compact tool carrier 100 are not needed to offset loads provided by the tool 122 (such as when the tool 122 is loaded), thereby improving a compactness of the compact tool carrier 100 and reducing an overall weight of the compact tool carrier 100. Additionally, the rearward position of the engine 111 on the compact tool carrier 100 prevents interference of the engine 111 and/or components of the engine 111, such as the oil pan 294 with the rear axle steps 165 (shown in FIG. 4) or rear torsion assembly 202.

### Engine Cooling System

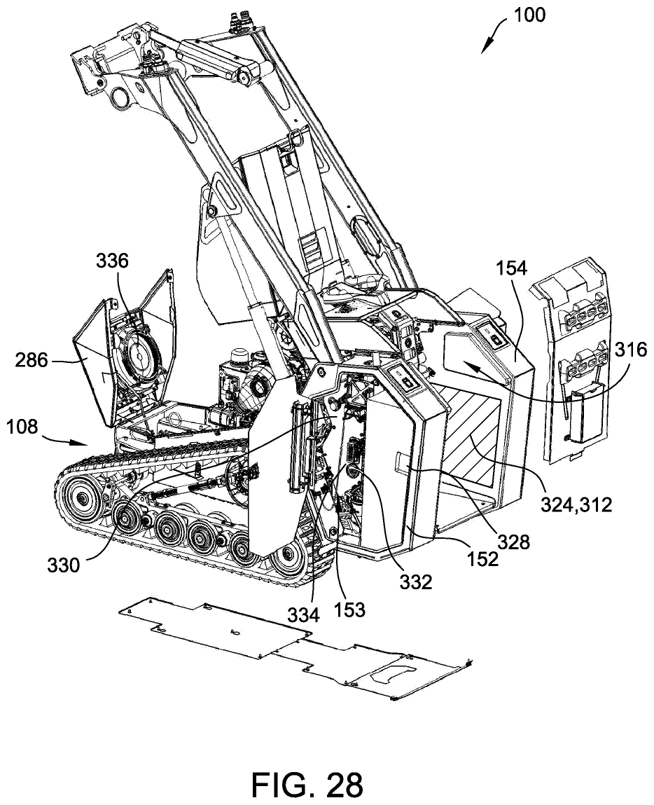

Referring to FIG. 27, the compact tool carrier 100 further includes an engine cooling system 306 for providing a liquid coolant to one or more components of the engine 111 (FIG. 25). The engine cooling system 306 includes a radiator 308, a coolant fan 310, a first air passage 312 (FIG. 28), and a second air passage 314 (FIG. 27).

In the illustrated embodiment, the radiator 308 and the coolant fan 310 are each disposed within the second compartment 155. In other embodiments, one or more components of the engine cooling system 306 may be disposed in the first compartment 153. Coolant tubing (not shown) is coupled to the radiator 308 to direct coolant between the radiator 308 and the engine 111 (FIG. 25). The fan 310 directs air flow over the radiator 308 to cool warmed coolant in the radiator 308 provided from the engine 111. In the example embodiment, the fan 310 is a variable speed, bi-directional fan that is driven by an electric motor 311 (FIG. 27).

The second compartment frame 154 extends transversely between an interior side 316 (FIG. 28) facing the operator station 114 and the first compartment frame 152, and an exterior side 318 (FIG. 27) facing outwards of the compact tool carrier 100. A second compartment door 320 at least partially defines the exterior side 318 and is moveable between an open position, as shown in FIG. 27, and closed position, as shown in FIG. 20.

The second compartment door 320 includes ducting 322 which extends through the door 320 and defines the second air passage 314. Specifically, as shown in FIGS. 24 and 27, the ducting 322 is provided on both sides of the second compartment door 320 to channel air between the second compartment 155 and an exterior of the compact tool carrier 100 when the second compartment door is closed. The ducting 322 is configured to exhaust air and may be adjustable to direct air based upon conditions, for example, directing air upwards of the compact tool carrier 100 may avoid stirring dust and other ground debris near the operator station. Alternatively, when the fan is reversed to intake air from the door 320 the ducting 322 may be adjusted to pull air from the rear of the machine to avoid dusty air caused by the tool 122.

As shown in FIG. 28, the interior side 316 of second compartment frame 154 includes venting 324 defining the first air passage 312. The venting 324 provides flow communication with the radiator 308 within second compartment 155. The first air passage 312 and second air passage 314 are not necessarily limited by the venting and ducting structures 322, 324 illustrated herein and different types of vents and/or ducts may be utilized in other embodiments. In some embodiments, the venting 324 and/or ducting 322 is adjustable to direct the air in a specific direction, such as towards a front of the operator station 114, towards the rear 104 of the compact tool carrier 100, towards the ground, upwards, or straight out (i.e., perpendicular) from the radiator 308.

In other embodiments, a second radiator (not shown) may be provided in the first compartment 153 as a component of engine cooling system 306 to provided further cooling to the engine 111 in addition to the radiator 308 provided in the second compartment 155.

Control of the fan 310 is adjustable to change a flow direction of the air through the radiator 308. For example, in colder weather, providing a hot air exhaust to an operator at the operator station 114 may improve operator comfort. According, the fan direction may be adjusted such that ducting 322 acts as the air intake and the venting 324 exhausts the heated air from the radiator 308 near and/or onto the operator at the operator station 114. Conversely, in warmer weather, the direction of the fan may be reversed such that the venting 324 acts as an air intake, providing a flow of ambient air at the operator station 114, and the hot air dispelled by the fan 310 is exhausted out of the ducting 322 and away from the operator. The operator may have the ability to control the fan direction and speed for the desired heating or cooling of the operator station 114, with the ability for a controller (not shown) of the compact tool carrier 100 to override the operator setting based on the cooling demands of the engine 111. The controller may operate the fan to provide a minimum cooling necessary to keep the acoustic noise generated by the fan 310 below a predetermined threshold.

The engine cooling system 306 described above, specifically the location of the radiator, fan, and ducting, and the effects of moving the air through the operator station, is independent of the operator suspension system and ground drive suspension system. In other embodiments, the configuration of the cooling system may be utilized on a compact tool carrier having a rigidly mounted operator station and/or a rigidly mounted ground drive system that are different from the operator station and drive systems described herein.

In the example embodiment, a fuse box 326 and a battery (not shown) of the compact tool carrier 100 are also disposed in the second compartment 155 (FIG. 27). The fuse box 326 and the battery are easily accessible by a technician when the second compartment door 320 is opened.

### Other Compartments

Referring to FIG. 28, the first compartment 153 contains a fuel tank 328, an oil inlet 330, an electrical connection port 332, such as a reflash plug, for performing a diagnostic on compact tool carrier 100, and an engine electrical terminal 334.

Referring to FIG. 28, in the example embodiment, the compact tool carrier 100 further includes a hydraulic oil cooler 336 (also referred to herein as an “oil cooler”) attached to the lower hood 286. The oil cooler 336 is accessible by an operator by opening the lower hood 286, as shown in the illustrated embodiment. The oil cooler 336 is positioned near the front 102 of the compact tool carrier 100, above a pump stack 290 (FIG. 7) and hydraulic tank 289.

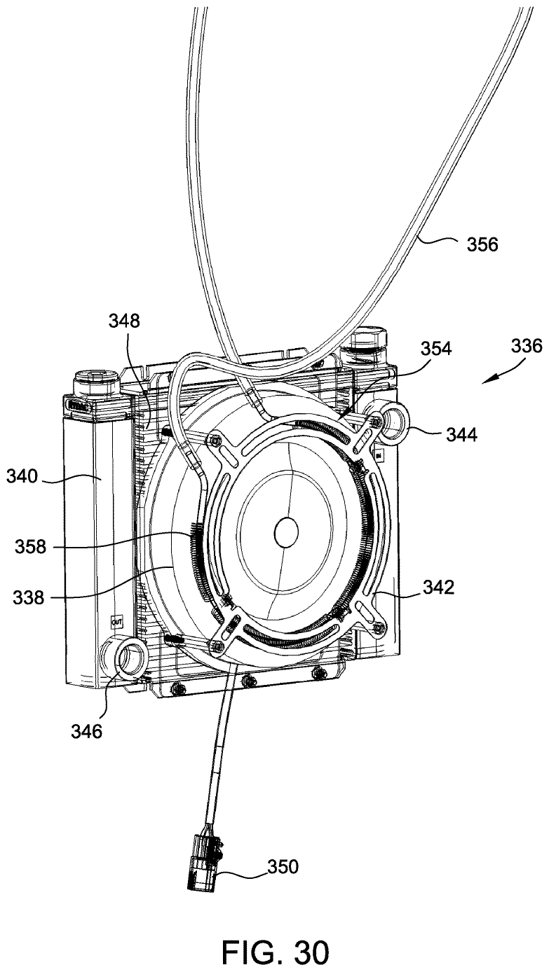

Referring to FIG. 30, the oil cooler 336 includes a fan hub 338, a radiator 340, and a fuel line bracket 342. The fan hub 338 contains a fan (not shown) that generates a flow of air over the radiator 340 and the fuel line bracket 342. The radiator 340 includes an inlet 344 and an outlet 346 for directing the oil through the radiator 340 and past the airflow generated by the fan. Specifically, oil used in the hydraulic components is directed through the oil cooler 336 and is and cooled by air from the fan of the oil cooler 336. The oil cooler 336 contains tubes (not shown) for carrying the oil to and from hydraulic components to the oil cooler 336. The radiator contains cooling fins 348 to facilitate heat exchange from oil to the radiator 340 and to the air. The radiator 340 also has an electrical connector 350 for transmitting data from a temperature sensor (not shown) and/or optionally for providing power to the oil cooler fan.

When lower hood 286 is in the closed position (FIG. 3) the fan of the oil cooler 336 may be configured to direct air past the hydraulic pump stack 290, hydraulic tank 289 (FIG. 7), and various other hydraulic components such as hoses and filters for cooling purposes. During normal operation, the fan directs air into the hydraulic compartment (e.g., such as through ducting or vents provided in the first or second sides 106, 108 of the compact tool carrier 100), over radiator 340, and discharges the air through lower hood venting 341 (FIG. 3). In some embodiments the fan is a controllable variable speed electric fan and a controller (not shown) of the compact tool carrier 100 may control the fan speed and direction based on feedback from a sensor, such as a hydraulic oil temperature sensor (not shown).

A fuel cooling system 354 (FIG. 30) is further connected to the oil cooler 336 for cooling unused fuel of the compact tool carrier 100, e.g., such as fuel drawn from the fuel tank 328, passed through the engine, unused by the engine, and returning to the fuel tank. The fuel cooling system 354 routes this unused fuel via a fuel line 356 to the oil cooler 336 prior to returning it to the fuel tank 328. The fuel line 356 is attached the fuel line bracket 342 which is mounted on the oil cooler 336. The fan hub 338 and fan (not shown) are positioned between the fuel line bracket 342 and fuel line 356, and the radiator 340. Fins 358 are attached to the fuel line 356 for facilitating heat exchange with air flowing over the fins 358. Accordingly, the fan (not shown) provided within the fan hub 338 is used both for cooling of the oil and fuel in fuel line 356.

Compared to conventional work machines, work machines of embodiments of the present disclosure have several advantages. In embodiments having a track suspension system, the shock and vibration from the terrain and ground drive components transmitted to the operator and components mounted on the chassis may be reduced. The track suspension counteracts “nose-dive” effects caused by loads on the loader arms and maintains a consistent frame height regardless of load. In embodiments in which the oil pan (e.g., and engine) is relatively rearward, additional room is provided for the axles of the track suspension while maintaining stability. The position of a radiator adjacent the operator station with a variable speed and bi-directional fan promotes air movement through the operator station which may warm the operator in cold weather and cool the operator in warm weather. In embodiments having a tilt actuator that is transversely offset from an operator's line of sight, the compact tool carrier may provide an improved view to the operator of the attachment plate and/or an attachment which may be beneficial for positioning the attachment while working.

Although described and illustrated on a single embodiment, the features described herein may operate independent of each other and may be utilized separately on other machines. For example, the operator suspension system is independent of the track suspension system. As a result, a compact tool carrier could be built with the track suspension system and a rigidly mounted operator station. Additionally, other aspects of the present disclosure, such as the track suspension system, operator suspension system, single tilt actuator loader configuration, engine placement configuration, radiator placement configuration, etc., may all each be independently utilized on other machines.

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a,” “an,” “the,” and “said” are intended to mean that there are one or more of the elements. The terms “comprising,” “including,” “containing,” and “having” are intended to be inclusive and mean that there may be additional elements other than the listed elements. The use of terms indicating a particular orientation (e.g., “top,” “bottom,” “side,” etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

1. A compact tool carrier comprising:
a chassis having a front and a rear, the compact tool carrier defining a longitudinal axis extending through the front and rear;
a tool connected to the chassis at the front;
a ground engaging drive mechanism for moving the compact tool carrier, the drive mechanism comprising a track frame defining an opening therein; and
a suspension assembly attached to the track frame and the chassis, the suspension assembly comprising:
a bar flexibly mounted to the chassis and defining a first transverse axis;
an arm connected at a first end to the bar and extending obliquely therefrom to a second, opposed end;
a torsion bar having a first end and a second end, the first end rotationally fixed to the arm at the second end of the arm, the torsion bar extending along a second transverse axis from the arm that is parallel to and longitudinally rearward of the first transverse axis; and
a connector link rotationally fixed to the second end of the torsion bar at a first end of the connector link and pivotally attached to the track frame at a second end of the connector link.

2. The compact tool carrier of claim 1, further comprising a torsion link including a torsion link arm and a torsion link shaft, the torsion link arm having a first and second end and the torsion link shaft having a first and second end, wherein the first end of the torsion link arm is pivotally coupled to the second end of the arm, the second end of the torsion link arm is fixedly attached to the first end of the torsion link shaft, and the second end of the torsion link shaft is attached to the second end of the connector link along a third transverse axis, the third transverse axis being offset from the second transverse axis, the torsion link being rotatable about the second and third transverse axes.

3. The compact tool carrier of claim 2, wherein the torsion link shaft creates the pivotal attachment to the track frame.

4. (canceled)

5. (canceled)

6. The compact tool carrier of claim 1, wherein the suspension assembly is
a front suspension assembly configured for attachment to the front of the chassis, the compact tool carrier further comprising:
rear suspension assembly configured for attachment to the rear of the chassis, the rear suspension assembly being further configured to connect the chassis to the track frame of the carrier, the rear suspension assembly including a first spring,
wherein the torsion bar of the front suspension assembly is configured to transfer forces from the front suspension assembly to the rear suspension assembly.

7. The compact tool carrier of claim 6, wherein the torsion bar is a linear spring.

8. The compact tool carrier of claim 6, wherein the torsion bar transfers forces from the front suspension assembly to the rear suspension assembly such that the front suspension assembly and the rear suspension assembly cooperate to maintain generally the same pitch of the chassis when the front of the chassis is in a loaded configuration and an unloaded configuration.

9. The compact tool carrier of claim 6, wherein the rear suspension assembly includes a rear axle and the front suspension assembly includes a front axle, and wherein the torsion bar is configured to cooperate with the first spring such that vertical displacement of the front axle when the compact tool carrier is loaded from an unloaded configuration matches the vertical displacement of the rear axle.

10. The compact tool carrier of claim 6, wherein the transfer of forces from the front suspension assembly to the rear suspension assembly increases a stiffness of the front suspension assembly.

11. The compact tool carrier of claim 6, wherein the forces in the front suspension assembly are transferred to the rear suspension assembly when the front of the compact tool carrier is loaded above a net weight of the compact tool carrier.

12. The compact tool carrier of claim 6, wherein the front suspension assembly includes a rubber torsion unit connected in series with the torsion bar, wherein the compact tool carrier is configured to receive a maximum load of the compact tool carrier when in a fully loaded configuration, and wherein, when in the fully loaded configuration, the rubber torsion unit rotates less than 22.5 degrees and the torsion bar rotates less than 12 degrees.

13. A compact tool carrier comprising:
a chassis having a front and a rear, the compact tool carrier defining a longitudinal axis extending through the front and rear;
a ground engaging drive mechanism for moving the compact tool carrier, the drive mechanism comprising a track frame defining an opening therein;
a front suspension assembly attached to the track frame and the chassis proximate the front, the front suspension assembly comprising:
a front torsion axle including a flexibly mounted bar defining a first front transverse axis;
an arm connected at a first end to the bar and extending obliquely therefrom to a second, opposed end, the arm including a shaft at the second end;
a torsion bar rotationally fixed at a first end to the shaft, the torsion bar extending along a second front transverse axis from the arm that is parallel to and longitudinally rearward of the first front transverse axis;
a torsion link pivotally attached to the shaft of the arm, the torsion link having a shaft extending along a third front transverse axis; and
a connector link rotationally fixed at a first end of the connector link to the torsion bar at a second end of the torsion bar, the torsion link being connected to a second end of the connector link; and
a rear suspension assembly attached to the chassis proximate the rear, the rear suspension assembly including a rear torsion axle defining a first transverse rear axis and a torsion arm connected to the rear torsion axle, the torsion arm defining a second transverse rear axis.

14. The compact tool carrier of claim 13, wherein the compact tool carrier defines a chassis level axis extending along a bottom of the chassis, a front mounting plane defined by an upper surface of the front axle, a rear mounting plane defined by an upper surface of the rear axle, a connector link axis extending through the second front traverse axis and the third front transverse axis, a front torsion arm axis extending through the first front transverse axis and the second front transverse axis, and a rear torsion arm axis extending through the first rear axis and the second rear transverse axis.

15. The compact tool carrier of claim 14, wherein, when the carrier is an unloaded condition, a first angle defined between the front torsion arm axis and the front mounting plane is between twenty degrees and thirty degrees.

16. The compact tool carrier of claim 15, wherein the first angle is about 16 degrees in a loaded condition and is about 10 degrees in a maximum load condition.

17. The compact tool carrier of claim 14, wherein, when the carrier in an unloaded condition, a second angle defined between the front torsion arm axis and the connector link axis is about 100 degrees.

18. The compact tool carrier of claim 17, wherein the second angle is about 92 degrees in a loaded condition of the carrier and is about 90 degrees in a maximum load condition of the carrier.

19. (canceled)

20. (canceled)

21. A suspension assembly for pivotally connecting a chassis of a compact tool carrier to a drive mechanism, the suspension assembly comprising:
a torsion axle having a bar flexibly mounted to the chassis, the bar defining a first transverse axis;
an arm connected at a first end to the bar and extending obliquely therefrom to a second, opposed end;
a torsion bar rotationally fixed to the arm at the second end, the torsion bar extending along a second transverse axis from the arm that is parallel to and longitudinally rearward of the first transverse axis;
a torsion link including a torsion arm and a torsion shaft, a first end of the torsion arm pivotally connected to the second end of the arm, the torsion shaft extending from a second end of the torsion arm along a third transverse axis that is parallel to and offset from the first transverse axis; and
a connector link rotationally fixed to the torsion bar at a first end of the connector link and rotationally fixed to the shaft of the torsion link, the connector link restricting transverse movement of the link and torsion bar relative to the drive mechanism.

22-41. (canceled)
